(19) United States
(12) Patent Application Publication
(10) Pub. No.: US 2019/0373666 A1
(43) Pub. Date: Dec. 5, 2019

(54) Systems and Methods for Wireless Communication Using Control and User Plane Separation in a Virtualized Radio Base Stations Network

(71) Applicant: Phazr, Inc., Allen, TX (US)

(72) Inventor: Farooq Khan, Allen, TX (US)

(21) Appl. No.: 15/992,147

(22) Filed: May 29, 2018

(51) Int. Cl. H04W 76/27; H04L 12/801; H04L 29/06; G06F 9/455

(52) U.S. Cl. CPC H04W 76/27; H04L 47/34; H04L 1/1812; G06F 9/45558; H04L 65/80

(57) ABSTRACT

Systems and methods for wireless communications with control and user plane separation includes radio units. The radio units include a central unit (CU) which includes a central unit user plane (CU-UP) located in at least one of the radio units. The central unit user plane (CU-UP) includes a first Packet Data Convergence Protocol (PDCP) layer and a Service Data Adaptation Protocol (SDAP) layer connected to the first Packet Data Convergence Protocol (PDCP) layer. The central unit (CU) also includes a central unit control plane (CU-CP) located remotely from the central unit user plane (CU-UP). The central unit control plane (CU-CP) includes a second Packet Data Convergence Protocol (PDCP) layer and a Radio Resource Control (RRC) layer connected to the second Packet Data Convergence Protocol (PDCP) layer. The central unit user plane (CU-UP) and the central unit control plane (CU-CP) are virtualized and shared by the radio units.

### BACKGROUND

The invention relates to wireless communications, and in particular relates to wireless communications with control and user plane separation in a virtualized radio base stations network.

### DESCRIPTION OF THE RELATED ART

Currently, wireless access methods are based on two popular standards: a wide area network (WAN) standard referred to as The Fourth Generation Long Term Evolution (4G LTE) system; and a local area network (LAN) standard called Wi-Fi. Wi-Fi is generally used indoors as a short-range wireless extension of wired broadband systems, whereas the 4G LTE systems provide wide area long-range connectivity both outdoors and indoors using dedicated infrastructure such as cell towers and backhaul to connect to the Internet.

As more people connect to the Internet, increasingly chat with friends and family, watch and upload videos, listen to streamed music, and indulge in virtual or augmented reality, data traffic continues to grow exponentially. In order to address the continuously growing wireless capacity challenge, the next generation of LAN and WAN systems are relying on higher frequencies referred to as millimeter waves in addition to currently used frequency bands below 7 GHz. The next generation of wireless WAN standard referred to as 5G New Radio (NR) is under development in the Third Generation Partnership Project (3GPP). The 3GPP NR standard supports both sub-7 GHz frequencies as well as millimeter wave bands above 24 GHz. In 3GPP standard, frequency range 1 (FR1) covers frequencies in the 0.4 GHz-6 GHz range. Frequency range 2 (FR2) covers frequencies in the 24.25 GHz-52.6 GHz range.

In addition to serving mobile, wearable and IoT (Internet of Things) devices, the next generation of wireless cellular systems using millimeter wave and sub-7 GHz spectrum are expected to provide high-speed (Gigabits per second) links to fixed wireless broadband routers installed in homes and commercial buildings.

In a traditional macro cellular network shown in FIG. 1A, antennas 104 and 106 and remote radio heads (RRH) 108, 110, 112 and 114 are mounted at the top of tower 116 and 118, with fibers 120 and 122 linking them to baseband units (BBUs) 124 and 126 situated at the base of the tower on the cell site. In centralized RAN or C-RAN architecture depicted in FIG. 1B, baseband units (BBUs) 130 and 132 are pulled off each site and centralized in a BBU pool, or C-RAN hub 136. The C-RAN hub 136 itself can serve a large number of cell sites and replaces the traditional BBUs located at each site.

In Cloud RAN architecture illustrated in FIG. 1C, a centralized baseband unit (BBU) processing 140 is further virtualized, enabling high utilization resource pooling with each virtual BBU 142 servicing multiple cells. A major drawback of C-RAN and Cloud RAN architectures is that they require extremely large bandwidth to carry the digitized baseband data on the so-called front-haul which is not only expensive but also adds latency negatively affecting the network capacity and performance.

### SUMMARY

Various aspects of the present disclosure are directed to wireless communications with control and user plane separation in a virtualized radio base stations network comprising a plurality of radio units. In one aspect of the disclosure, the radio units include a central unit (CU) which includes a central unit user plane (CU-UP) located in at least one of the radio units. The central unit user plane (CU-UP) includes a first Packet Data Convergence Protocol (PDCP) layer and a Service Data Adaptation Protocol (SDAP) layer connected to the first Packet Data Convergence Protocol (PDCP) layer. The central unit (CU) also includes a central unit control plane (CU-CP) located remotely from the central unit user plane (CU-UP). The central unit control plane (CU-CP) includes a second Packet Data Convergence Protocol (PDCP) layer and a Radio Resource Control (RRC) layer connected to the second Packet Data Convergence Protocol (PDCP) layer. The central unit user plane (CU-UP) and the central unit control plane (CU-CP) communicate with each other via an interface protocol. The central unit user plane (CU-UP) and the central unit control plane (CU-CP) are virtualized and shared by the plurality of radio units.

In an additional aspect of the disclosure, the central unit user plane (CU-UP) and the central unit control plane (CU-CP) communicate with each other via an E1 interface protocol.

In an additional aspect of the disclosure, the virtualized base station node includes a remote radio head including a lower physical layer (PHY-Low), an analog-to-digital converter (ADC), a digital-to-analog converter (DAC), MIMO antenna arrays, and a radio frequency (RF) transceiver. In an additional aspect of the disclosure, the virtualized base station node also includes a distributed unit connected to the remote radio head. The distributed unit includes a Radio Link Control (RLC) layer, a Medium Access Control (MAC) layer, and a higher physical (PHY-high) layer. The remote radio head, the distributed unit and the central unit user plane (CU-UP) are integrated into the radio units. The central unit control plane (CU-CP) is located remotely from the remote radio head and the distributed unit.

In an additional aspect of the disclosure, the radio base station node is a 5G NR (New Radio) base station Node B (gNB).

In an additional aspect of the disclosure, the distributed unit is a gNB distributed unit (gNB-DU).

In an additional aspect of the disclosure, the central unit control plane (CU-CP) communicates with the gNB-DU via F1-C(F1 control plane) protocol standardized by 3GPP.

In an additional aspect of the disclosure, the central unit user plane (CU-UP) of one gNB communicates with the central unit user plane (CU-UP) of another gNB via Xn user plane (Xn user plane) protocol standardized by 3GPP.

In an additional aspect of the disclosure, a NG control plane interface is provided (NG-C) between the NR gNB-CU-CP and a Core Access and Mobility Management Function (AMF) module in a NG-Core.

In an additional aspect of the disclosure, a NG user plane (NG-U) interface is provided between the gNB-CU-UP and an UPF (User Plane Function) module in a NG-Core.

In an additional aspect of the disclosure, an F1 user plane (F1-U) interface is provided between the gNB-CU-UP and the gNB-DU within virtualized radio base stations.

In an additional aspect of the disclosure, an Xn control plane (Xn-C) interface is provided between the gNB-CU-CP of one gNode B and the gNB-CU-CP entity of another gNodeB.

In an additional aspect of the disclosure, the virtualized radio base station node is connected to a 4G LTE radio base station enhanced Node B (LTE eNB). The gNB-CU-UP entity in the virtualized radio base station node communicates with the 4G LTE eNB using a X2-U (X2 user-plane) protocol standardized by 3GPP.

In an additional aspect of the disclosure, the radio base station node is connected to a 4G LTE Evolved Packet Core (EPC). The virtualized radio base station node communicates with the 4G LTE Evolved Packet Core (EPC) using a S1-U protocol standardized by 3GPP.

In an additional aspect of the disclosure, the central unit user plane (CU-UP) including the first Packet Data Convergence Protocol (PDCP) layer and the Service Data Adaptation Protocol (SDAP) layer are implemented as one or more virtual machines.

In an additional aspect of the disclosure, the central unit control plane (gNB-CU-CP) including the second Packet Data Convergence Protocol (PDCP) layer and the Radio Resource Control (RRC) layer are implemented as one or more virtual machines.

In an additional aspect of the disclosure, the central unit user plane (gNB-CU-UP) including the first Packet Data Convergence Protocol (PDCP) layer and the Service Data Adaptation Protocol (SDAP) layer are implemented as one or more containers.

In an additional aspect of the disclosure, the central unit control plane (gNB-CU-CP) including the second Packet Data Convergence Protocol (PDCP) layer and the Radio Resource Control (RRC) layer are implemented as one or more containers.

In an additional aspect of the disclosure, a virtualized radio base station node comprises a plurality of radio units. The radio units include a remote radio head including a lower physical layer (PHY-Low), an analog-to-digital converter (ADC), a digital-to-analog converter (DAC), MIMO antenna arrays, and a radio frequency (RF) transceiver. The radio units also include a distributed unit connected to the remote radio head. The distributed unit includes a Radio Link Control (RLC) layer, a Medium Access Control (MAC) layer, and a higher physical (PHY-high) layer. The radio units also include a central unit (CU) connected to the distributed unit. The central unit includes a central unit user plane (gNB-CU-UP) and a central unit control plane (gNB-CU-CP). The central unit user plane (gNB-CU-UP) includes a first Packet Data Convergence Protocol (PDCP) layer and a Service Data Adaptation Protocol (SDAP) layer. The central unit control plane (gNB-CU-CP) includes a second Packet Data Convergence Protocol (PDCP) layer and a Radio Resource Control (RRC) layer. The remote radio head (RRH), the distributed unit (gNB-DU), and the central unit user plane (gNB-CU-UP) are located in at least one of the radio units. The central unit control plane (gNB-CU-CP) is physically separated from the central unit user plane (gNB-CU-UP) and is located remotely from the central unit user plane (gNB-CU-CP). The central unit user plane (gNB-CU-CP) and the central unit control plane (gNB-CU-CP) communicate with each other via an interface protocol. The remote radio head, the distributed unit and the central unit are virtualized and shared by the plurality of radio units.

In an additional aspect of the disclosure, the central unit user plane (gNB-CU-UP) and the central unit control plane (gNB-CU-CP) communicate with each other via an E1 interface protocol. In an additional aspect of the disclosure, the radio base station node is a 5G NR (New Radio) base station NodeB (gNB-). In an additional aspect of the disclosure, the distributed unit is a gNodeB distributed unit (gNB-DU). In an additional aspect of the disclosure, the central unit control plane (gNB-CU-CP) communicates with the gNB-DU via F1-C(F1 control plane) protocol standardized by 3GPP. In an additional aspect of the disclosure, the central unit user plane (gNB-CU-UP) of one gNB communicates with the central unit user plane (CU-UP) of another gNB via Xn user plane (Xn-U) protocol standardized by 3GPP.

In an additional aspect of the disclosure, a NG control plane interface is provided (NG-C) between the NR gNodeB and a Core Access and Mobility Management Function (AMF) module in a NG-Core. In an additional aspect of the disclosure, a NG user plane (NG-U) interface is provided between the gNB-CU-UP and an UPF (User Plane Function) module in a NG-Core. In an additional aspect of the disclosure, an F1 user plane (F1-U) interface is provided between the gNB-CU-UP and the gNB-DU. In an additional aspect of the disclosure, an Xn user plane (Xn-U) interface is provided between the gNB-CU-UP of one gNode B and the gNB-CU-UP entity of another gNodeB.

In an additional aspect of the disclosure, the radio base station node is connected to a 4G LTE radio base station enhanced Node B (LTE eNB). The radio base station node communicates with the 4G LTE eNB using a X2-U (X2 user-plane) protocol standardized by 3GPP.

In an additional aspect of the disclosure, the radio base station node is connected to a 4G LTE Evolved Packet Core (EPC). The radio base station node communicates with the 4G LTE Evolved Packet Core (EPC) using a S1-U protocol standardized by 3GPP.

In an additional aspect of the disclosure, the central unit user plane (gNB-CU-UP) including the first Packet Data Convergence Protocol (PDCP) layer and the Service Data Adaptation Protocol (SDAP) layer are implemented as one or more virtual machines.

In an additional aspect of the disclosure, the central unit control plane (gNB-CU-CP) including the second Packet Data Convergence Protocol (PDCP) layer and the Radio Resource Control (RRC) layer are implemented as one or more virtual machines.

In an additional aspect of the disclosure, the central unit user plane (gNB-CU-UP) including the first Packet Data Convergence Protocol (PDCP) layer and the Service Data Adaptation Protocol (SDAP) layer are implemented as one or more containers.

In an additional aspect of the disclosure, the central unit control plane (gNB-CU-CP) including the second Packet Data Convergence Protocol (PDCP) layer and the Radio Resource Control (RRC) layer are implemented as one or more containers.

In an additional aspect of the disclosure, a virtualized radio base station node includes a plurality of radio units. The radio units comprise a central unit (gNB-CU) which includes a central unit control plane (gNB-CU-CP) and a central unit user plane (gNB-CU-UP). The central unit user plane (gNB-CU-UP) includes a first Packet Data Convergence Protocol (PDCP) layer and a Service Data Adaptation Protocol (SDAP) layer connected to the first Packet Data Convergence Protocol (PDCP) layer. The central unit control plane (gNB-CU-CP) is located remotely from the central unit user plane (gNB-CU-UP). The central unit control plane (gNB-CU-CP) includes a second Packet Data Convergence Protocol (PDCP) layer and a Radio Resource Control (RRC) layer connected to the second Packet Data Convergence Protocol (PDCP) layer. The radio units also include a user plane function (UPF) of a 5G Next Generation Packet Core (NG-Core) connected to the central unit user plane (gNB-CU-UP). The central unit user plane (gNB-CU-UP) and the central unit control plane (gNB-CU-CP) communicate with each other via an interface protocol. The central unit user plane (gNB-CU-UP), the central unit control plane (gNB-CU-CP) and the user plane function (UPF) of the 5G next Generation Packet Core (NG-Core) are virtualized and shared by the plurality of radio units.

In an additional aspect of the disclosure, the user plane function (UPF) of a 5G Next Generation Packet Core (NG-Core) is integrated in the radio base station node.

In an additional aspect of the disclosure, the user plane function (UPF) of a 5G Next Generation Packet Core (NG-Core) is implemented as one or more virtual machines.

In an additional aspect of the disclosure, the user plane function (UPF) of a 5G Next Generation Packet Core (NG-Core) is implemented as one or more containers.

In an additional aspect of the disclosure, a method for wireless communication includes receiving a first uplink signal at a first virtualized radio unit and receiving a second uplink signal at a second virtualized radio unit. The first and second uplink signals are processed by one or more virtual machines shared by both the first and second radio units. In an additional aspect of the disclosure, a first virtual machine implements at least one of a central unit user plane (gNB-CU-UP) located in at least one of the radio units. The central unit user plane (gNB-CU-UP) includes a first Packet Data Convergence Protocol (PDCP) layer and a Service Data Adaptation Protocol (SDAP) layer are connected to the first Packet Data Convergence Protocol (PDCP) layer. In an additional aspect of the disclosure, a second virtual machine implements at least one of a central unit control plane (gNB-CU-CP) located remotely from the central unit user plane (gNB-CU-UP). The central unit control plane (gNB-CU-CP) includes a second Packet Data Convergence Protocol (PDCP) layer and a Radio Resource Control (RRC) layer connected to the second Packet Data Convergence Protocol (PDCP) layer. In an additional aspect of the disclosure, a third virtual machine implements at least one of a user plane function (UPF) of a 5G Next Generation Packet Core (NG-Core) connected to the central unit user plane (gNB-CU-UP). The first and second uplink signals are transmitted by a user equipment (UE), wherein the UE switches connection from the first virtualized radio unit to the second virtualized radio unit without a transfer of context information from the first virtualized radio unit to the second virtualized radio unit.

In an additional aspect of the disclosure, the first and second virtualized radio units are located in a same radio base station node. In an additional aspect of the disclosure, the first and second virtualized radio units are located in different radio base station nodes.

In an additional aspect of the disclosure, a method for wireless communication includes transmitting a first downlink signal by a first virtualized radio unit and transmitting a second downlink signal by a second virtualized radio unit. Prior to transmission the first and second downlink signals are processed by one or more virtual machines shared by both the first and second radio units. A first virtual machine implements at least one of a central unit user plane (gNB-CU-UP) located in at least one of the radio units. The central unit user plane (gNB-CU-UP) includes a first Packet Data Convergence Protocol (PDCP) layer and a Service Data Adaptation Protocol (SDAP) layer connected to the first Packet Data Convergence Protocol (PDCP) layer. A second virtual machine implements at least one of a central unit control plane (gNB-CU-CP) located remotely from the central unit user plane (gNB-CU-UP). The central unit control plane (gNB-CU-CP) includes a second Packet Data Convergence Protocol (PDCP) layer and a Radio Resource Control (RRC) layer connected to the second Packet Data Convergence Protocol (PDCP) layer. A third virtual machine implements at least one of a user plane function (UPF) of a 5G Next Generation Packet Core (NG-Core) connected to the central unit user plane (CU-UP).

In an additional aspect of the disclosure, the method includes transmitting, by the first virtualized radio unit, the first downlink signal to a user equipment (UE) and transmitting, by the second virtualized radio unit, the second downlink signal to the UE during a second time interval. The UE switches connection from the first virtualized radio unit to the second virtualized radio unit without a transfer of context information from the first virtualized radio unit to the second virtualized radio unit.

### BRIEF DESCRIPTION OF THE DRAWINGS

FIGS. 1A-1C illustrate macro cellular network, C-RAN and Cloud RAN architectures.

FIG. 2 illustrates a wireless system in accordance with disclosed embodiments.

FIG. 3 is a block diagram of a virtualized base station node according to disclosed embodiments.

FIGS. 4A-4B illustrate virtualized base stations network according to disclosed embodiments.

FIG. 5 illustrates virtualization of a radio base station implementing three sectors.

FIG. 6 illustrates virtualized base stations network according to disclosed embodiments.

FIG. 7 illustrates virtualization of base stations using containers according to disclosed embodiments.

FIGS. 8A-8B illustrate virtualization of sectors and sub-sectors of a radio base station according to disclosed embodiments.

FIGS. 9A-9B illustrate a wireless communication device connected to a virtualized base stations network.

FIG. 10 illustrates control and user plane separation in a virtualized radio base stations network.

FIG. 11 illustrates a control and user plane separated virtualized radio base stations network connected to a 4G LTE Evolved Packet Core (EPC) and 4G LTE radio base station enhanced Node B (LTE eNB)

FIG. 12A illustrates a control and user plane separated virtualized radio base stations network connected to a 5G Next Generation (NG) Packet Core.

FIG. 12B illustrates control and user plane interfaces and protocol stacks.

FIG. 12C illustrates control and user plane separation in accordance with one embodiment of the present disclosure.

FIG. 13 illustrates virtualization of protocols and network interfaces in the virtualized base stations network.

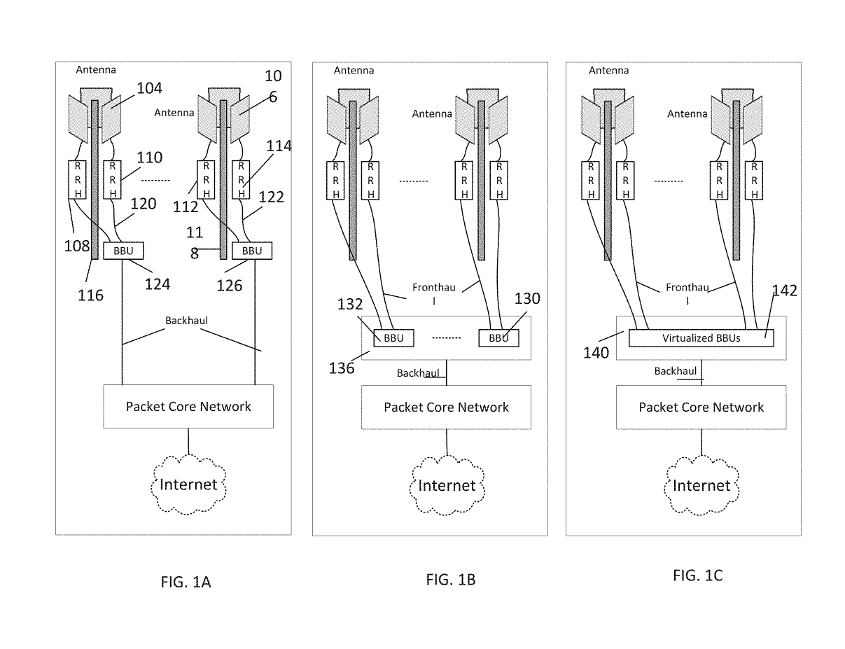

### DETAILED DESCRIPTION

The techniques described herein may be used for various wireless communication networks such as wireless LAN, fourth Generation (4G) LTE cellular mobile, Fifth Generation (5G) cellular mobile and other networks such as, for example, fixed wireless access (FWA) networks. The terms “network” and “system” are often used interchangeably.

Embodiments of the present disclosure which will be described below provide methods and systems for wireless communications with control and user plane separation in a virtualized radio base stations network.

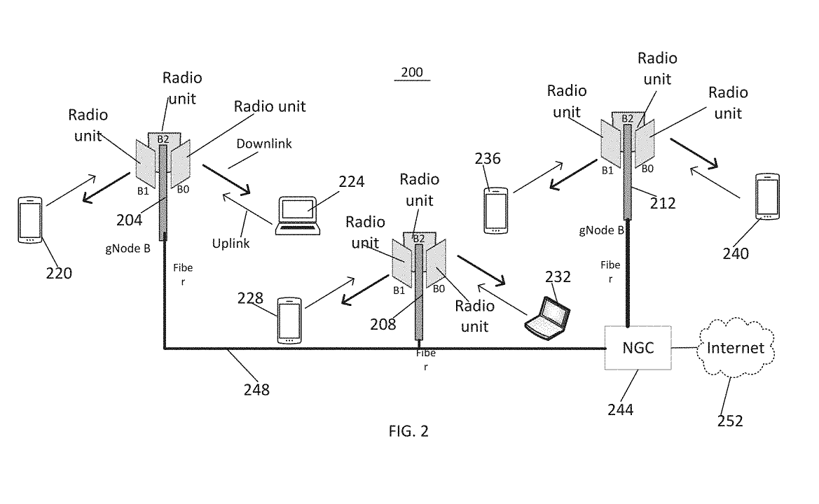

FIG. 2 illustrates a wireless communication network 200 (also referred to as a radio base stations network 200) according to an embodiment of the present disclosure. The wireless communication network 200 (or radio base stations network 200) may use both millimeter wave spectrum above 24 GHz and sub-7 GHz spectrum. The wireless communication network 200 may use millimeter wave spectrum above 24 GHz for both uplink or downlink, sub-7 GHz spectrum for both uplink or downlink or millimeter wave spectrum above 24 GHz for downlink and sub-7 GHz spectrum for uplink.

Referring to FIG. 2, the wireless network 200 (or radio base stations network 200) includes radio base station nodes 204, 208 and 212 (also referred to as gNode Bs) that communicate with communication devices 220, 224, 228, 232, 236 and 240. The communication devices 220, 224, 228, 232, 236 and 240 are also referred to as user equipments (UEs), and the terms “communication device” and “user equipment” (UE) are often used interchangeably. The communication devices or UEs receive downlink signals from the radio base stations, and the communication devices or UEs transmit uplink signals to the radio base stations.

The radio base station nodes 204, 208 and 212 are virtualized and can provide 360 degrees coverage by using three radio units or sectors. For example, the radio base station node 204 includes radio units or sectors B0, B1, B2. The radio base station node 208 includes radio units or sectors B0, B1, B2. The radio base station node 212 includes radio units or sectors B0, B1, B2.

According to an embodiment of the present disclosure, each radio unit or sector may cover 120 degrees. Each radio unit or sector may be further divided into P sub-sectors with each sub-sector covering 120/P degrees. For example, for the case when a radio unit or sector is further divided into three sub-sectors, each sector provides 40 degrees coverage. The virtualized radio base station nodes gNode Bs 204, 208 and 212 are connected to a network 244 (e.g., Next Generation Core (NGC) network) using a communication link 248 (e.g., high-speed fiber backhaul link). The network 244 may be connected to the Internet 252. The virtualized radio base station node 204 serves communication devices 220 and 224, the virtualized radio base station node 208 serves communication devices 228 and 232, and the virtualized radio base station node 212 serves communication devices 236 and 240. The communication devices may, for example, be smartphones, laptop computers, desktop computers, augmented reality/virtual reality (AR/VR) devices or any other communication devices.

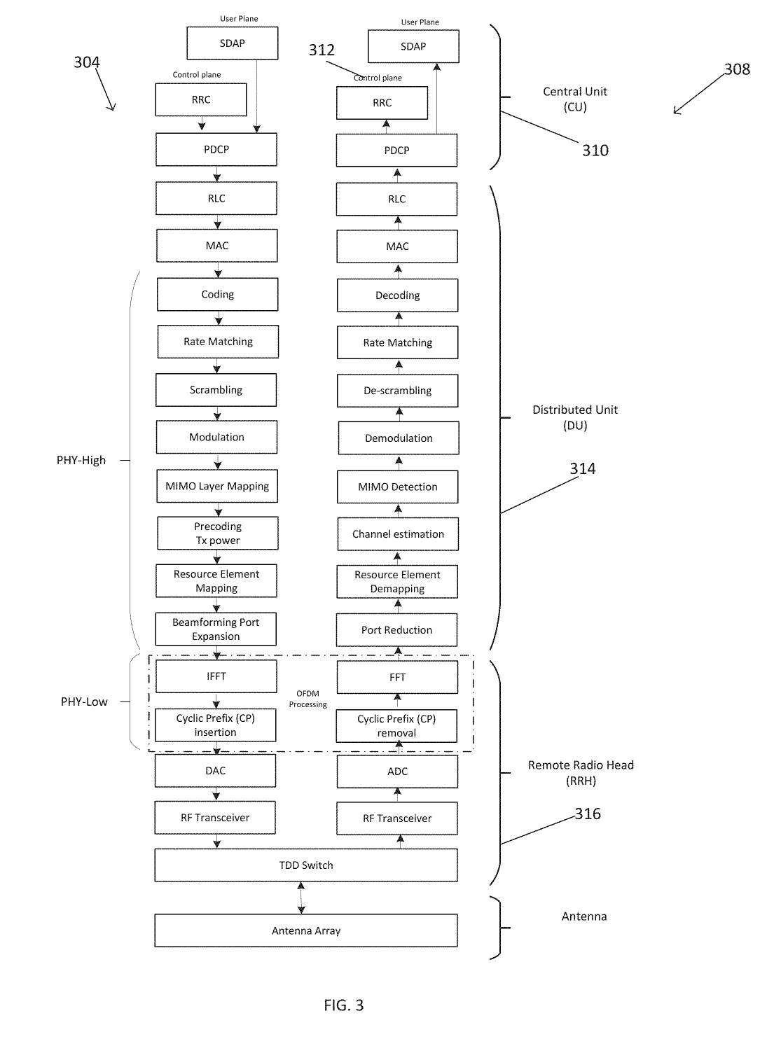

FIG. 3 is a block diagram of a virtualized base station node according to an embodiment of the present disclosure. In both transmit and receive chains 304 and 308, a central unit (CU) 310 includes a Packet Data Convergence Protocol (PDCP) layer, and a Service Data Adaptation Protocol (SDAP) layer. A control plane 312 includes a Radio Resource Control (RRC) on top of the PDCP layer in both the transmit and receive chains 304 and 308.

A distributed unit (DU) 314 includes a Radio Link Control (RLC) layer, a Medium Access Control (MAC) layer, and higher physical (PHY-high) layer in both the transmit and receive chains 304 and 308. A remote radio head (RRH) 316 which is also referred to as remote radio unit (RRU) includes lower physical layer (PHY-Low) processing, analog/RF functions and antennas. The RRH 316 also includes, analog-to-digital converter (ADC), digital-to-analog converter (DAC), radio frequency (RF) transceiver, and an optional TDD (Time Division Duplexing) switch.

The main services and functions of the RRC sublayer include, broadcast of system information, paging, security functions including key management, QoS management functions, UE measurement reporting and control of the reporting, Detection of and recovery from radio link failure and NAS (Non-Access Stratum) message transfer to/from NAS from/to UE. RRC also controls the establishment, configuration, maintenance and release of Signaling Radio Bearers (SRBs) and Data Radio Bearers (DRBs); mobility functions including handover, context transfer, UE cell selection and reselection and control of cell selection and reselection. Moreover, RRC is in charge of establishment, maintenance and release of an RRC connection between the UE and NG-RAN including: addition, modification and release of carrier aggregation; addition, modification and release of Dual Connectivity in NR or between E-UTRA and NR.

The main services and functions of SDAP include mapping between a QoS flow and a data radio bearer and marking QoS flow ID (QFI) in both downlink and uplink packets. The main services and functions of the PDCP sublayer for the user plane include: sequence numbering, header compression, header decompression, reordering, duplicate detection, retransmission of PDCP SDUs (Service Data Units), ciphering, deciphering, integrity protection, PDCP SDU discard, duplication of PDCP PDUs (Protocol Data Units), PDCP re-establishment and PDCP data recovery for RLC AM (Acknowledged Mode).

The RLC sublayer supports three transmission modes: Transparent Mode (TM), Unacknowledged Mode (UM) and Acknowledged Mode (AM). The main services and functions of the RLC sublayer depend on the transmission mode and include: transfer of upper layer PDUs, sequence numbering independent of the one in PDCP (UM and AM), error Correction through ARQ (AM only), segmentation (AM and UM) and re-segmentation (AM only) of RLC SDUs, reassembly of SDU (AM and UM), duplicate detection (AM only), RLC SDU discard (AM and UM), RLC re-establishment and protocol error detection (AM only).

The main services and functions of the MAC sublayer include: mapping between logical channels and transport channels, multiplexing/demultiplexing of MAC SDUs into/from transport blocks (TB) delivered to/from the physical layer, padding, scheduling information reporting, error correction through Hybrid ARQ, priority handling between UEs by means of dynamic scheduling and priority handling between logical channels.

The main services and functions of the high physical layer (PHY-high) include: transport block CRC attachment, code block segmentation, code block CRC attachment, channel coding, physical-layer hybrid-ARQ processing, rate matching, bit-interleaving, modulation (QPSK, 16QAM, 64QAM and 256QAM etc.), layer mapping, pre-coding and mapping to assigned resources and antenna ports. The lower physical layer (PHY-Low) implements OFDM (Orthogonal Frequency Division Multiplexing) processing that includes FFT/IFFT (Fast Fourier Transform/Inverse Fast Fourier Transform) functions as well as addition and removal of cyclic prefix (CP).

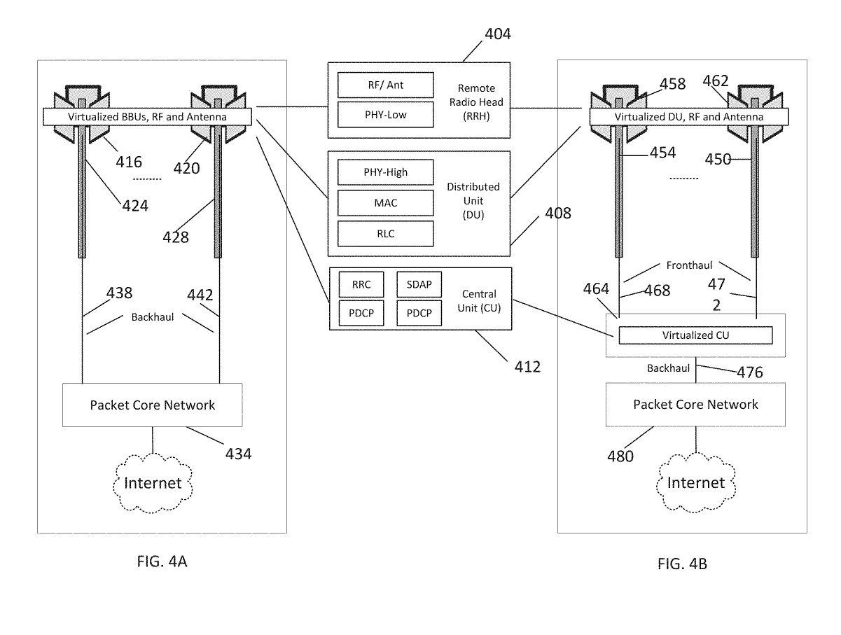

FIGS. 4A-B illustrate cliff computing virtualized base stations network according to embodiments of the present disclosure. Referring to FIG. 4A, a base stations network includes radio base station nodes 424 and 428. Each radio base station node includes a plurality of radio units. A remote radio head (RRH) 404, a distributed unit (DU) 408, and a central unit (CU) 412 are inter-connected with each another and are integrated into the radio unit 416 of the base station node 424 and into the radio unit 420 of the base station node 428. The integration of the RRH 404, DU 408, CU 412 into the radio units is referred to as “cliff compute” architecture, and the resulting radio base station nodes 424 and 428 are referred to as cliff compute virtualized radio base station nodes 424 and 428.

The cliff compute virtualized radio base station nodes 424 and 428 communicate with a network 434 (e.g., Next Generation Packet Core (NGC) network) via backhaul links 438 and 442. Both DU 408 and CU 412 are virtualized in the cliff compute virtualized radio base station nodes 424 and 428. Thus, the base station nodes 424 and 428 share the DU 408 and CU 412.

In other embodiments, some functions of the RRH 404 can also be virtualized. In the architecture of FIG. 4B, the cliff compute virtualized radio base station nodes 450 and 454 implement the remote radio head (RRH) 404, the distributed unit (DU) 408, integrated with the radio units 458 and 462. The central unit (CU) 412 is virtualized and located at a central location 464 such as a central office or operator's data center. These cliff compute virtualized radio base station nodes 450 and 454 communicate with the central unit (CU) 412 via fronthaul links 468 and 472. These fronthaul links 468 and 472 between the distributed unit (DU) 408 and the central unit (CU) 412 do not require large bandwidth as they do not carry the digitized baseband data but rather carry standard Ethernet or IP packets. The virtualized central unit (CU) 412 communicates with a network 476 (e.g., Next Generation Packet Core (NGC) network) via backhaul links 480.

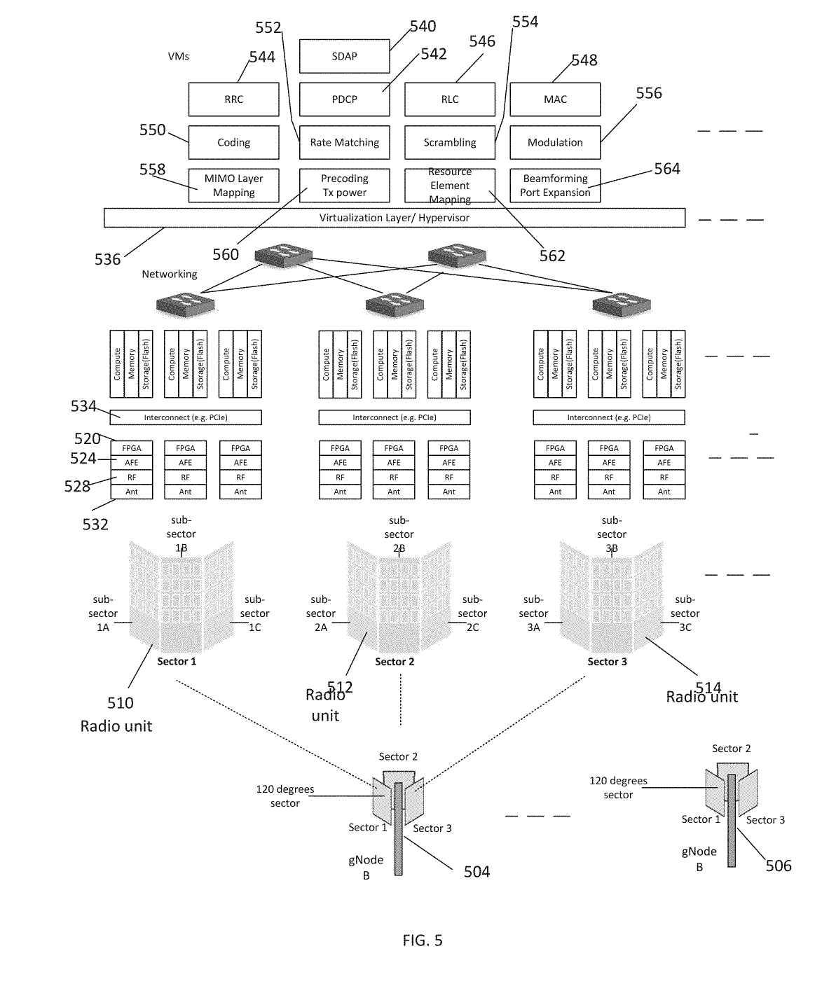

FIG. 5 illustrates virtualization of a radio base station node 504 implementing three radio units or sectors: radio unit or sector 510 (sector 1), radio unit or sector 512 (sector 2), and radio unit or sector 514 (sector 3). Each radio unit or sector is further divided into three sub-sectors. For example, sector 510 (sector 1) is divided into three sub-sectors: sub-sector 1A, sub-sector 1B and sub-sector 1C.

Each sub-sector (e.g., sub-sector 1A, sub-sector 1B) or a group of sub-sectors may include field-programmable gate arrays (FPGA), Analog Front-End (AFE), radio frequency (RF) transceivers, and antenna arrays for beamforming and MIMO (Multiple Input Multiple Output). For example, sub-sector 1A may include a field-programmable gate array (FPGA) 520, an Analog Front-End (AFE) 524, radio frequency (RF) transceivers 528, and antenna arrays 532 for beamforming and MIMO (Multiple Input Multiple Output).

The field-programmable gate array (FPGA) 520 performs functions such as OFDM processing using FFT (Fast Fourier Transform) and the IFFT (Inverse Fast Fourier Transform), addition and removal of Cyclic Prefix (CP). In other embodiments, FPGA can also implement functions such as modulation, channel coding and decoding using Low-Density Parity Check (LDPC) codes.

The Analog Front-End (AFE) 524 implements Digital Up Conversion (DUC) and Digital Down Conversion (DDC) that are DSP (Digital Signal Processing) sample rate conversion techniques used to increase or decrease the sampling rate of a signal respectively. The increased sampled rate digital signals are converted to analog domain by digital-to-analog converters (DAC) inside the AFE 524. The received analog signals are converted to digital signals by analog-to-digital converters (ADC) and sent to DDC block inside the AFE 524. The AFE 524 communicates with the FPGA 520 using a standardized serial interface such as JESD204B standard. In other embodiments, the functions of the AFE 524 can be implemented including the digital-to-analog converters (DAC) and analog-to-digital converters (ADC) can be integrated with the FPGA 520 in a single system-on-a-chip (SoC).

According to embodiments of the present disclosure, each sub-sector (e.g., sub-sector 1A, sub-sector 1B) or a group of sub-sectors also implement general-purpose compute such as, for example, processors using Intel x86 architecture, memory such as DDR4 SDRAM (double data rate fourth-generation synchronous dynamic random-access memory), storage such as Flash (solid-state non-volatile computer storage). These functions connect to the FPGA 520 via, for example, PCI Express (Peripheral Component Interconnect Express) 534 or other high-speed inter-connect. The communication between the sectors and sub-sectors is achieved via Ethernet or IP (Internet Protocol) switching.

According to embodiments of the present disclosure, a virtualization layer 536 separates the radio base stations physical hardware (antenna, RF, AFE, FPGA, processor, memory, and storage etc.) and software by emulating hardware using software. For example, a software called a hypervisor can be used to create the virtualization layer 536 that separates the physical resources from the virtual environments where the functions of a radio base station run. Hypervisors can sit on top of an operating system (Type 2) or be installed directly onto hardware (Type 1). Type 2 hypervisors support guest virtual machines by coordinating calls for CPU, memory, disk, network and other resources through the physical host's operating system. Examples of this type of hypervisor include VMware Fusion, Oracle Virtual Box, Oracle VM for x86, Solaris Zones, Parallels and VMware Workstation. In contrast, a Type 1 hypervisor (also called a bare metal hypervisor) is installed directly on physical host server hardware like an operating system. Type 1 hypervisors run on dedicated hardware. Examples of this type of hypervisor include Oracle OVM for SPARC, ESXi, Hyper-V and KVM. Because the type 2 hypervisor needs to go through the operating system and is managed by the OS, the type 2 hypervisor (and its virtual machines) runs less efficiently (slower) than a type 1 hypervisor.

Referring to FIG. 5, according to an embodiment of the present disclosure, central unit (CU) functions such as Service Data Adaptation Protocol (SDAP) 540, Packet Data Convergence Protocol (PDCP) 542, Radio Resource Control (RRC) 544, and the distributed unit (DU) functions such as Radio Link Control (RLC), Medium Access Control (MAC), and higher physical (PHY-high) layer are implemented as one or more virtual machines. In the example of FIG. 5, Service Data Adaptation Protocol (SDAP) 540, Packet Data Convergence Protocol (PDCP) 542, Radio Resource Control (RRC) 544, Radio Link Control (RLC) 546, Medium Access Control (MAC) 548 functions are implemented as virtual machines (VMs). Moreover, higher physical layer functions such as channel coding 550, rate matching 552, scrambling 554, modulation 556, MIMO layer mapping 558, precoding 560, resource element mapping 562 and beamforming port expansion 564 are implemented as virtual machines (VMs).

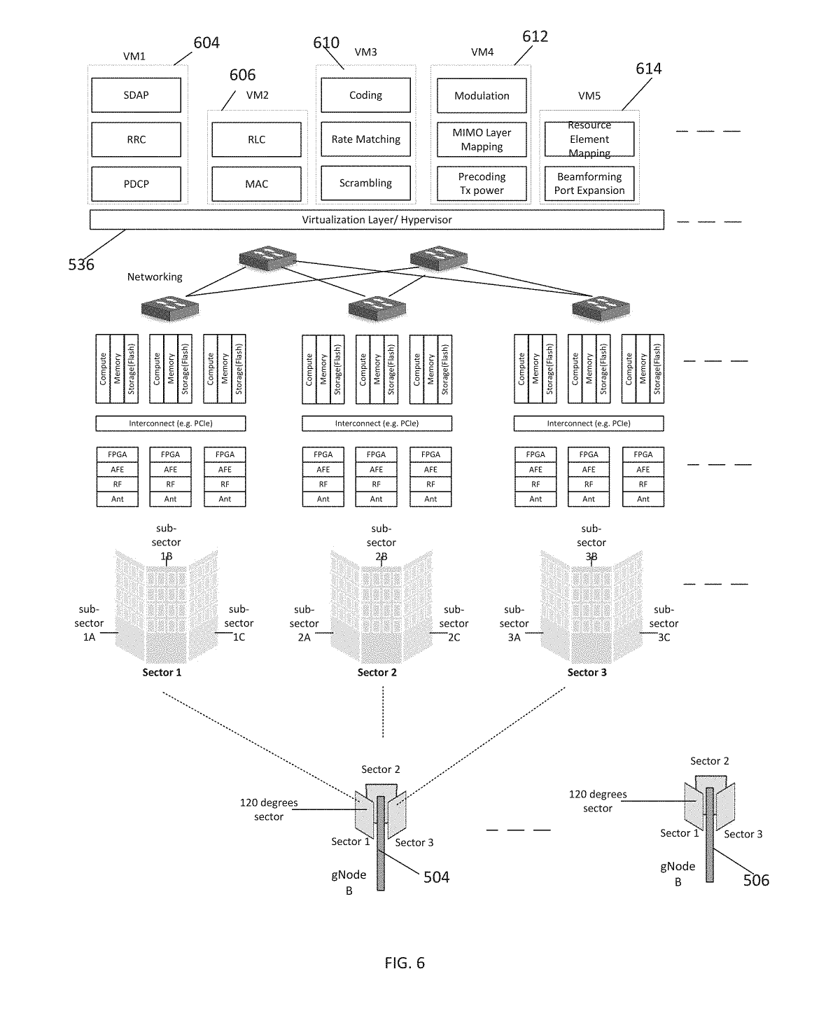

FIG. 6 illustrates virtualized base stations network according to some disclosed embodiments. The Service Data Adaptation Protocol (SDAP) 540, Packet Data Convergence Protocol (PDCP) 542 and Radio Resource Control (RRC) 544 functions are implemented as a single virtual machine 604 (VM1). Radio Link Control (RLC) 546 and Medium Access Control (MAC) 548 are implemented as another single virtual machine 606 (VM2). The higher physical (PHY-high) layer functions are implemented as three virtual machines. Virtual machine 610 (VM3) implements channel coding 550, rate matching 552 and scrambling 554. Virtual machine 612 (VM4) implements modulation 556, MIMO layer mapping 558, precoding 560. Finally, virtual machine 614 (VM5) implements resource element mapping 562 and beamforming port expansion 564. In other embodiments, same functions can be implemented in more than one virtual machine. For example, virtual machine 606 (VM2) implementing Radio Link Control (RLC) 546 and Medium Access Control (MAC) 548 can be replicated in multiple virtual machines.

According to other embodiments of the present disclosure, container technology is used for virtualization, in which a single operating system on a host can run many different applications. Virtual machines take up a lot of system resources because each virtual machine runs not just a full copy of an operating system, but a virtual copy of all the hardware that the operating system needs to run. This quickly adds up to a lot of RAM and CPU cycles. In contrast, all that a container requires is enough of an operating system, supporting programs and libraries, and system resources to run a specific program. This way, containers have a significant lesser overhead than virtual machines. Containers use a layer of software called container engine on top of the operating system. An example of container engine is Docker. Also, because of the sharing of the kernel with the host operating system, containers can start and stop extremely fast.

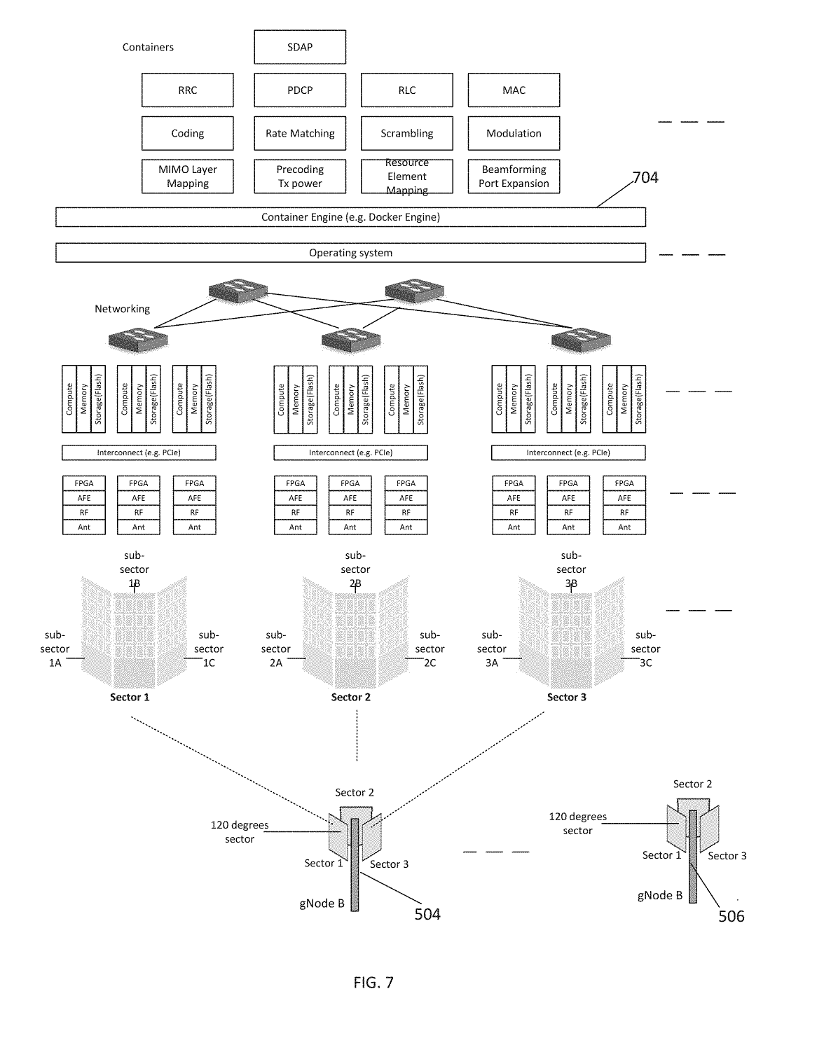

FIG. 7 illustrates virtualization of base station nodes 504 and 506 using containers according to an embodiment of the present disclosure. The central unit (CU) functions such as Service Data Adaptation Protocol (SDAP), Packet Data Convergence Protocol (PDCP), Radio Resource Control (RRC), and the distributed unit (DU) functions such as Radio Link Control (RLC), Medium Access Control (MAC), and higher physical (PHY-high) layer functions are implemented as containers 704. There are many container formats available. Docker is an open-source container format that is supported by Google Kubernetes Engine. Each container shares the host OS kernel and, usually, the binaries and libraries, too.

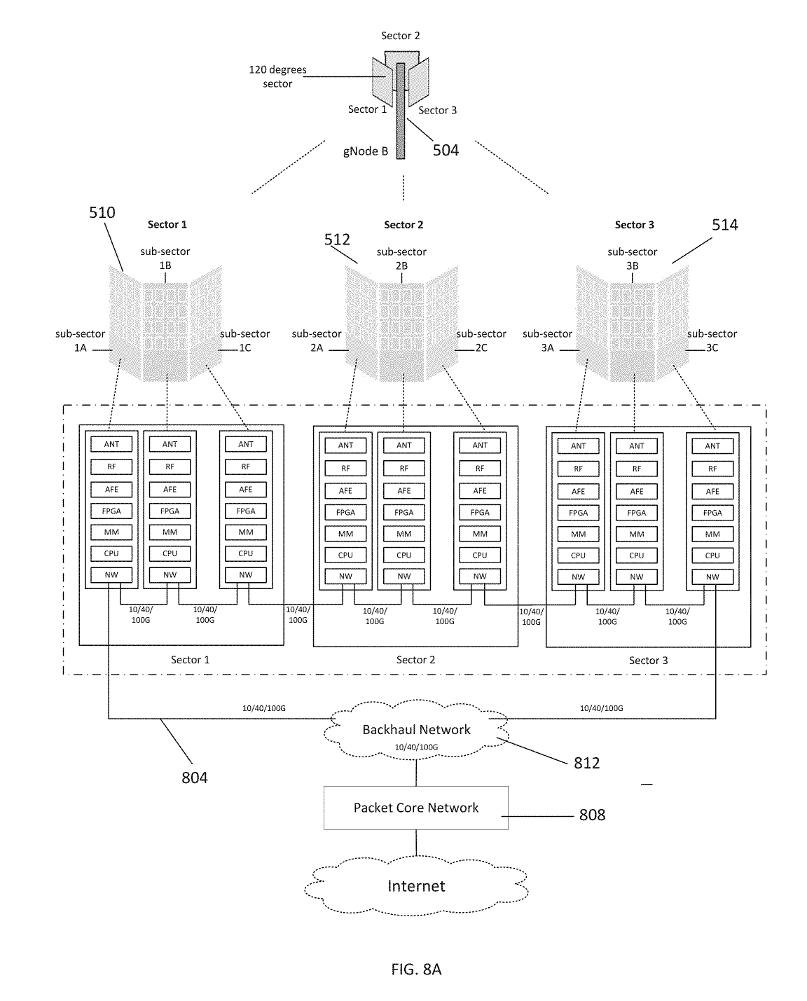

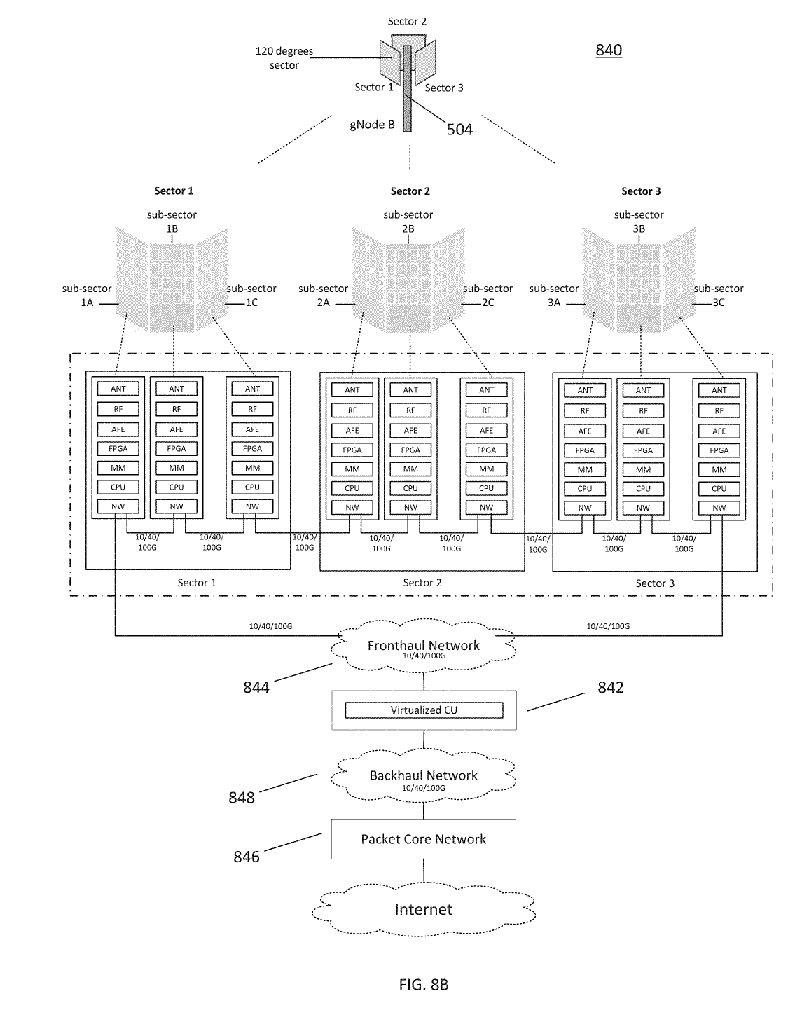

FIGS. 8A-B illustrate virtualization of radio units (sectors) and sub-sectors of a radio base station node 504 according to an embodiment of the present disclosure. Multiple radio units (radio unit 510, radio unit 512, and radio unit 514) and sub-sectors are wired together in sequence or in a ring using a link 804 (e.g., Ethernet or IP link). Referring to FIG. 8A, the remote radio head (RRH) 316, the distributed unit (DU) 314, and the central unit (CU) 310 are integrated with the radio units 510, 512, and 514 in cliff compute virtualized radio base station node 504. The RRH 316, the DU 314, and the CU 310 are described before and also illustrated in FIG. 3.

The cliff compute virtualized radio base station node 504 communicates with a network 808 (e.g., Next Generation Packet Core (NGC) network) via a backhaul network 812. Both the DU 314 and the CU 310 are virtualized in the cliff compute virtualized radio base station nodes. In other embodiments, some functions of the RRH 404 can also be virtualized.

FIG. 8B illustrates a cliff compute virtualized radio base station network 840 where a virtualized central unit (CU) 842 is located at a central location such as a central office or operator's data center. The remote radio head (RRH) 316 and the distributed unit (DU) 314 are integrated with the antenna unit in the cliff compute virtualized radio base station node 504. The cliff compute virtualized radio base station node 504 communicates with the virtualized central unit (CU) 842 via a fronthaul network 844. These fronthaul links do not require large bandwidth as they carry standard Ethernet or IP packets. The virtualized central unit (CU) 842 communicates with a network 846 (e.g., Next Generation Packet Core (NGC) network) via standard Ethernet or IP backhaul network 848.

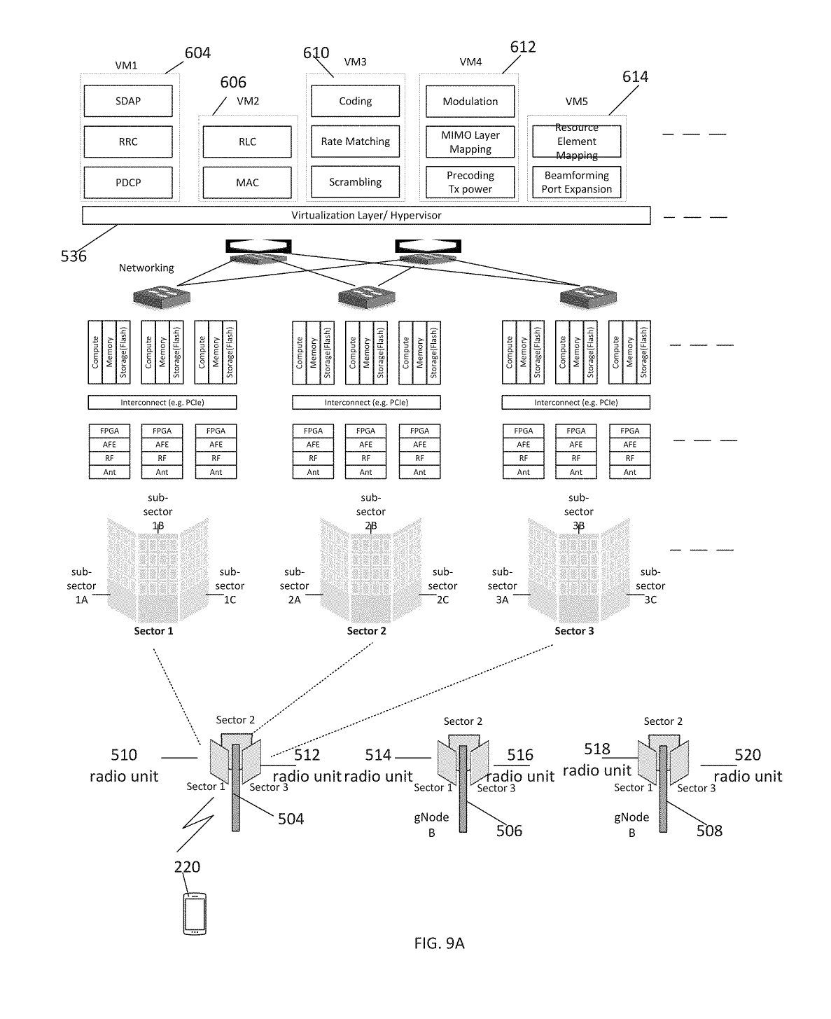

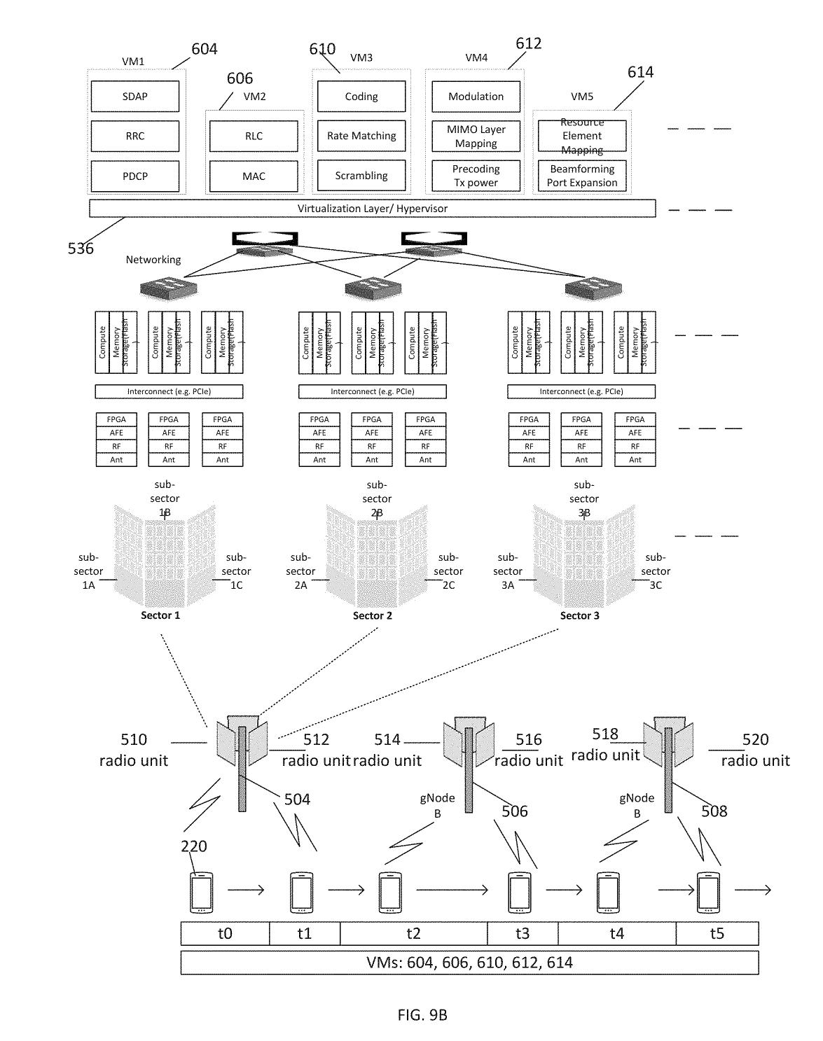

FIGS. 9A-B illustrate a wireless communication device 220 connected to the virtualized base stations network via radio unit 510 according to an embodiment of the present disclosure. The radio network functions for the wireless communication device 220 (or user equipment) are provided by virtual machines 604, 606, 610, 612 and 614. The virtual machine 604 (VM1) implements the Service Data Adaptation Protocol (SDAP) 540, Packet Data Convergence Protocol (PDCP) 542 and Radio Resource Control (RRC) 544 functions. The virtual machine 606 (VM2) implements the Radio Link Control (RLC) 546 and Medium Access Control (MAC) 548 functions. The higher physical (PHY-high) layer functions are implemented as three virtual machines. Virtual machine 610 (VM3) implements channel coding 550, rate matching 552 and scrambling 554. Virtual machine 612 (VM4) implements modulation 556, MIMO layer mapping 558, precoding 560. Finally, virtual machine 614 (VM5) implements resource element mapping 562 and beamforming port expansion 564. In other embodiments, same functions can be implemented in more than one virtual machine.

Referring to FIG. 9B, wireless communication device 220 (or user equipment) changes its physical connection from one radio unit to the other while receiving network services from the same virtual machines according to some embodiments of the present disclosure. The wireless communication device 220 may change its physical connection from one radio unit to the other to support mobility or due to changing channel conditions or loading in the network. For example, when a wireless communication device is moving away from a first radio unit and moving closer to a second radio unit due to mobility, its signal strength from the first radio unit will degrade due to increasing propagation distance between the communication device and the first radio unit while the signal strength will increase to the second radio unit due to decreasing propagation distance between the communication device and the second radio unit. Also, when a radio unit is heavily loaded with many communication devices connected to it, the throughput experienced by each communication device degrades. Under these circumstances, one or more communication devices may decide to connect to another radio unit for improved throughput performance.

In time period t0, wireless communication device 220 is physically connected to the radio unit 510 while being served by the virtual machines 604, 606, 610, 612 and 614. In time period t1, wireless communication device 220 is physically connected to the radio unit 512 while being served by the virtual machines 604, 606, 610, 612 and 614. In time period t2, wireless communication device 220 is physically connected to the radio unit 580 while being served by the virtual machines 604, 606, 610, 612 and 614. In time period t3, wireless communication device 220 is physically connected to the radio unit 582 while being served by the virtual machines 604, 606, 610, 612 and 614. In time period t4, wireless communication device 220 is physically connected to the radio unit 586 while being served by the virtual machines 604, 606, 610, 612 and 614. In time period t5, wireless communication device 220 is physically connected to the radio unit 588 while being served by the virtual machines 604, 606, 610, 612 and 614. The ability of a wireless communication device to change its physical connection to the radio unit while being served by the same virtual machine reduces network overhead and latency because there is no need to transfer communication device context information from one radio unit to the other when communication device changes its physical connection to a different radio unit. Since multiple radio units are served by the virtual machines, the communication device context information, which may be stored in at least one of the virtual machines, is available to the radio units. Thus, the communication device 220 can switch connection from a first radio unit to a second radio unit without a transfer of the context information from the first radio unit to the second radio unit. A communication device context information may, for example, include C-RNTI (Cell Radio Network Temporary Identifier) which is used to identify the UE during exchange of all information over the air. The C-RNTI is assigned during the setup of the RRC Connection. The context may also include states of different protocols such as Hybrid ARQ retransmission buffer state in the MAC, unacknowledged RLC PDU sequence numbers in RLC AM, header compression state in the PDCP, SDAP QoS flow ID (QFI) marking for a data radio bearer and RRC connection state.

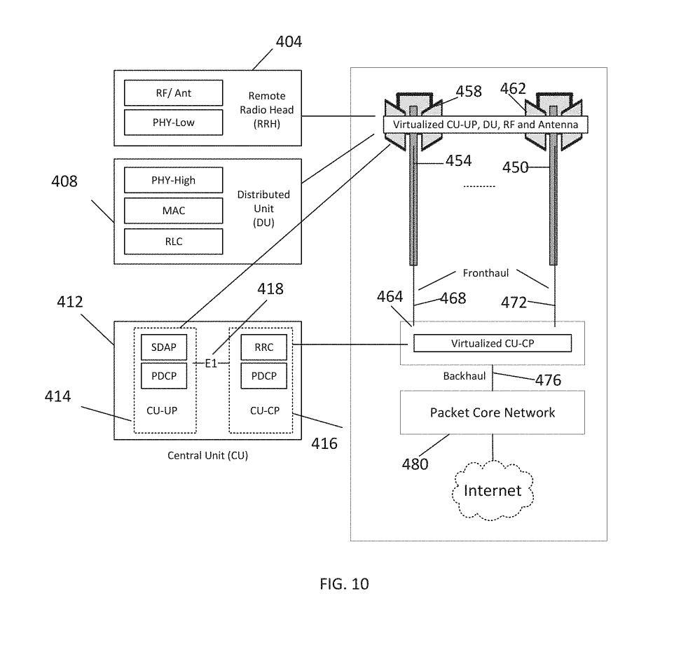

FIG. 10 illustrates a virtualized radio base stations network with control and user plane separation according to embodiments of the present disclosure. Referring to FIG. 10, virtualized radio base station nodes 450 and 454 implement a remote radio head (RRH) 404, a distributed unit (gNB-DU) 408, integrated with radio units 458 and 462. A central unit (gNB-CU) 412 is separated into a central unit user plane (gNB-CU-UP) 414 and a central unit control plane (gNB-CU-CP) 416. The central unit control plane (gNB-CU-CP) 416 is virtualized and may be located at a central location 464 such as, for example, a central office or operator's data center. The central unit user plane (gNB-CU-UP) 414 and the central unit control plane (gNB-CU-CP) 416 may use a standard E1 interface protocol 418 to communicate with each other. The remote radio head (RRH) 404, the distributed unit (gNB-DU) 408, and the central unit user plane (gNB-CU-UP) 414 are integrated into the radio unit 458 of the base station node 454 and into the radio unit 462 of the base station node 450. The cliff compute virtualized radio base station nodes 450 and 454 communicate with the central unit control plane (gNB-CU-CP) 416 via fronthaul or mid-haul links 468 and 472.

Separating the central unit user plane (gNB-CU-UP) 414 and the central unit control plane (gNB-CU-CP) 416 allows each plane resource to be scaled independently. The fronthaul links 468 and 472 do not require large bandwidth as they do not carry digitized baseband data but rather carry standard Ethernet or IP packets. The virtualized central unit control plane (gNB-CU-CP) 464 communicates with a network 476 (e.g., Next Generation Packet Core (NGC) network) via backhaul links 480. The central unit control plane (gNB-CU-CP) implements Radio Resource Control (RRC) and Packet Data Convergence Protocol (PDCP) layer functions. The central unit control plane (gNB-CU-CP) also implements X2-C, F1-C and E1 interfaces. The central unit user plane (gNB-CU-UP) implements Service Data Adaptation Protocol (SDAP) and Packet Data Convergence Protocol (PDCP) layer functions. The central unit user plane (gNB-CU-UP) also implements X2-U, F1-U and E1 interfaces. The logically centralized control plane enables control and optimization decisions to be made with global visibility offering the benefits of greater network performance and efficiency.

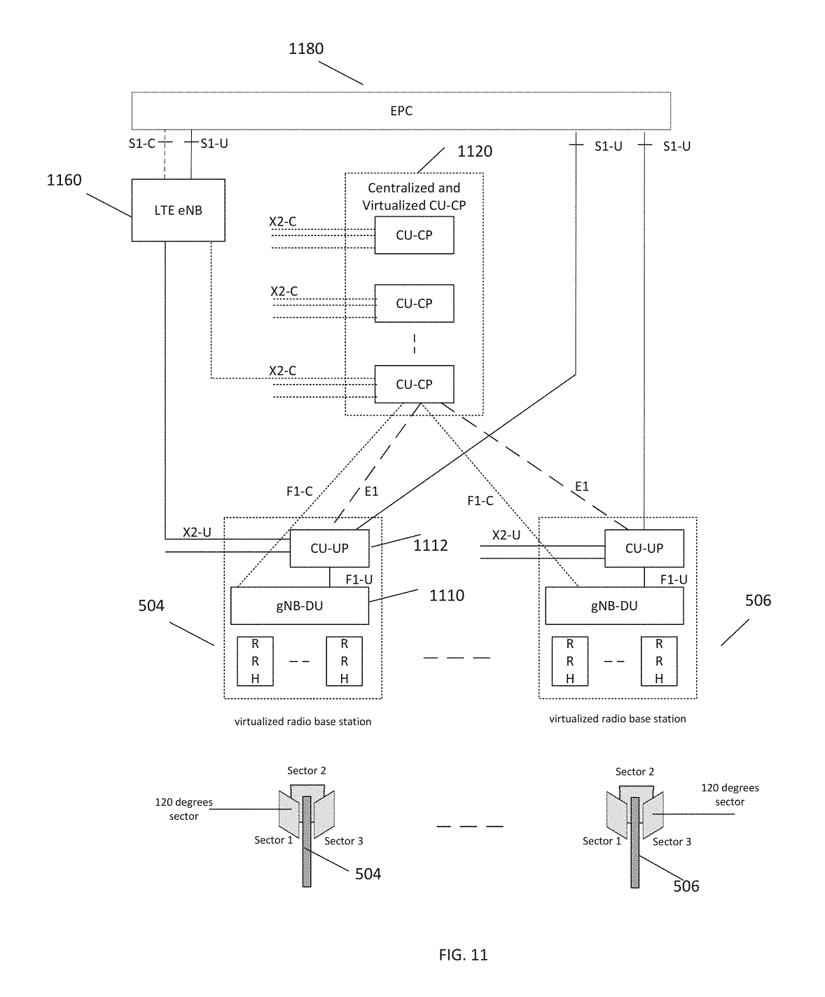

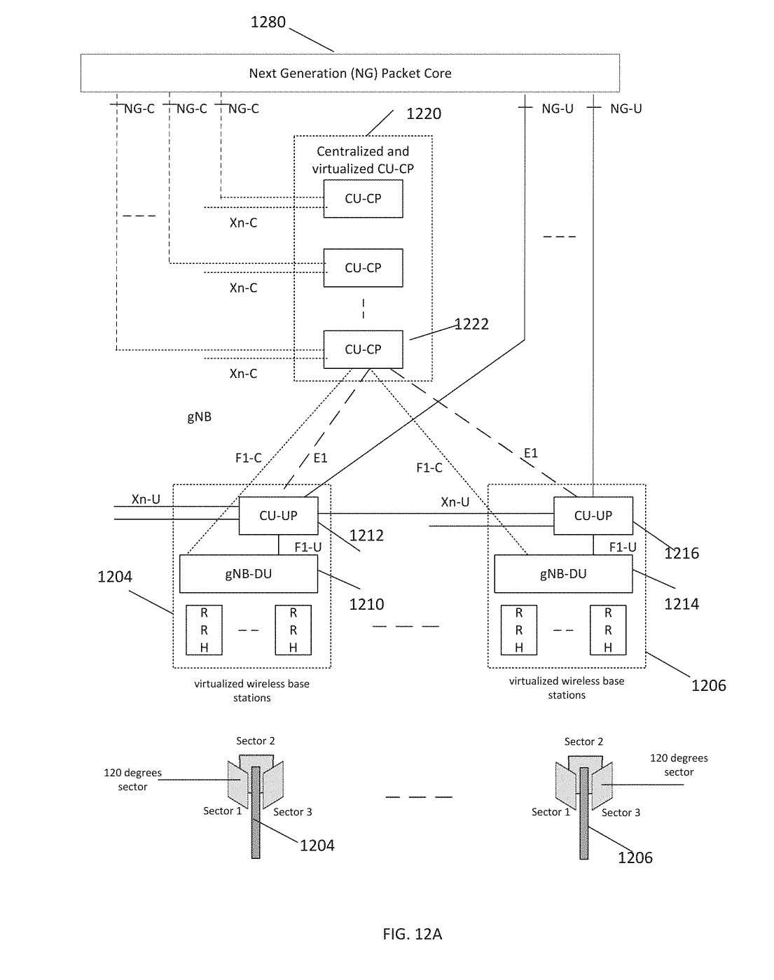

FIG. 11 illustrates a control and user plane separated virtualized radio base stations network connected to a 4G LTE Evolved Packet Core (EPC) and 4G LTE radio base station enhanced Node B (LTE eNB) according to embodiments of the present disclosure. Referring to FIG. 11, a virtualized radio base station 504 communicates with the 4G LTE Evolved Packet Core (EPC) 1180 using the S1-U protocol standardized by 3GPP. The virtualized radio base station 504 communicates with the 4G LTE eNB using the X2-U (X2 user-plane) protocol standardized by 3GPP. The central unit control plane (gNB-CU-CP) 1120 is virtualized and may be located, for example, at a central location such as a central office or operator's data center. The central unit control plane (gNB-CU-CP) 1120 communicates with the 4G LTE eNB using the X2-C(X2 control-plane) protocol standardized by 3GPP.

The virtualized radio base station 504, shown in FIG. 11, integrates one or more remote radio heads (RRH), a 5G base station Node B distributed unit (gNB-DU), and a central unit user plane (gNB-CU-UP). The central unit control plane (gNB-CU-CP) 1120 communicates with the central unit user plane (gNB-CU-UP) 1112 in the virtualized radio base station 504 via E1 protocol standardized by 3GPP. The central unit control plane (gNB-CU-CP) 1120 communicates with the gNB-DU 1110 in the virtualized radio base station 504 via F1-C(F1 control plane) protocol standardized by 3GPP. The central unit user plane (gNB-CU-UP) 1112 communicates with the gNB-DU 1110 in the virtualized radio base station 504 via F1-U (F1 user plane) protocol standardized by 3GPP.

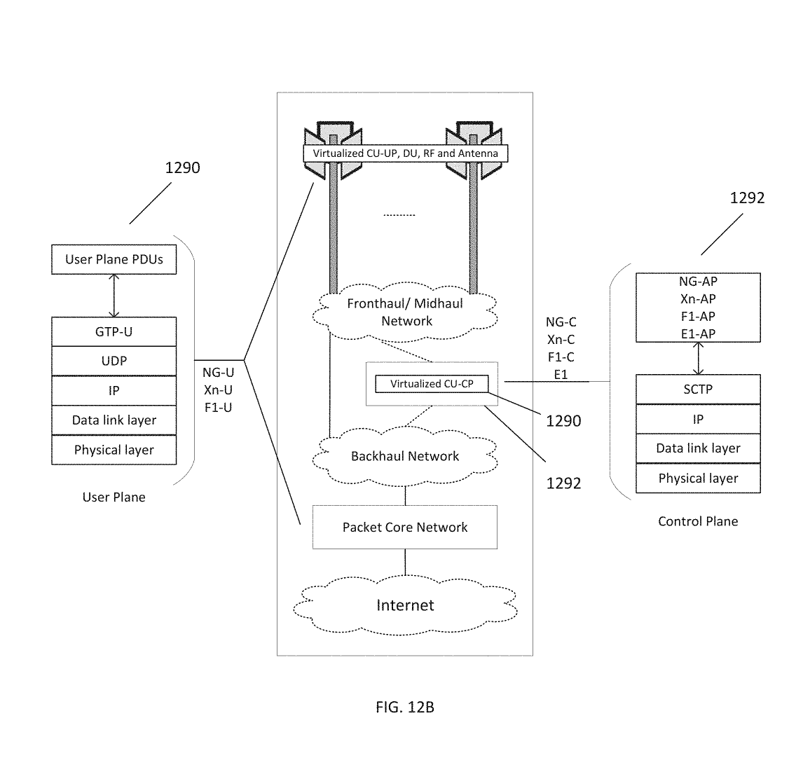

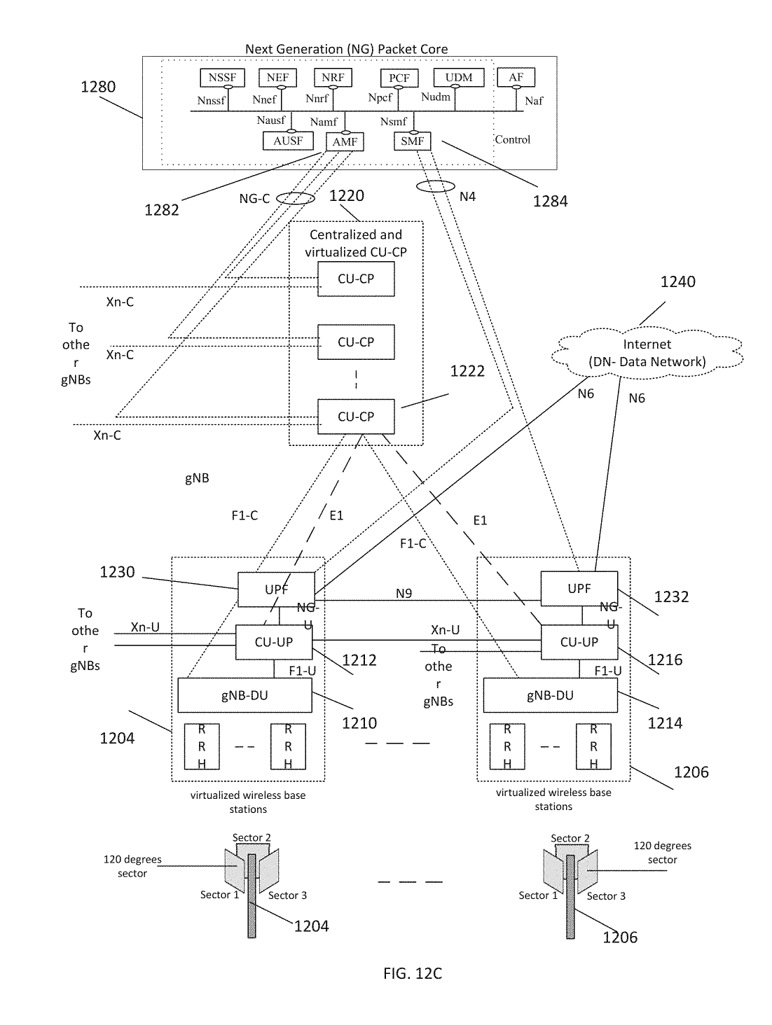

FIG. 12A illustrates a control and user plane separated virtualized radio base stations network connected to a 5G Next Generation (NG) Packet Core (NGPC according to embodiments of the present disclosure. Referring to FIG. 12A, virtualized radio base station 1204 communicates with the Next Generation (NG) Packet Core 1280 using the NG-U (Next Generation user plane) protocol standardized by 3GPP. The virtualized radio base station 1204 communicates with another virtualized radio base station 1206 using the Xn-U (Xn user-plane) protocol standardized by 3GPP. A central unit control plane (gNB-CU-CP) 1220 is virtualized and may be located at a central location such as a central office or operator's data center. The central unit control plane (gNB-CU-CP) 1220 communicates with the Next Generation (NG) Packet Core 1280 using the NG-C(Next Generation control plane) protocol standardized by 3GPP.

The virtualized radio base station 1204, shown in FIG. 12A, integrates one or more remote radio heads (RRH), a 5G NR (New Radio) base station Node B (gNodeB or gNB) distributed unit (gNB-DU) 1210, and a central unit user plane (CU-UP) 1212. The central unit control plane (gNB-CU-CP) 1220 communicates with the central unit user plane (gNB-CU-UP) 1212 in the virtualized radio base station 1204 via E1 protocol standardized by 3GPP. The central unit control plane (gNB-CU-CP) 1120 communicates with the gNB-DU 1210 in the virtualized radio base station 1204 via F1-C(F1 control plane) protocol standardized by 3GPP. The central unit user plane (gNB-CU-UP) 1212 communicates with the gNB-DU 1210 in the virtualized radio base station 1204 via F1-U (F1 user plane) protocol standardized by 3GPP. The central unit user plane (gNB-CU-UP) 1212 in the virtualized radio base station 1204 communicates with the central unit user plane (gNB-CU-UP) 1216 in the virtualized radio base station 1206 via Xn-U (Xn user plane) protocol standardized by 3GPP. The central unit control plane (gNB-CU-CP) 1220 communicates with central unit control plane (gNB-CU-CP) of other gNBs using the Xn-C(Xn control-plane) protocol standardized by 3GPP. A gNB consists of one or more RRHs, one or more gNB-DUs and one or more gNB-CU-UPs and one or more gNB-CU-CPs.

FIG. 12B illustrates control and user plane separation in a virtualized radio base station network according to an embodiment of the present disclosure. A central unit control plane (gNB-CU-CP) 1290 is virtualized and may be located at a central location such as, for example, a central office or operator's data center 1292. The central unit control plane (gNB-CU-CP) 1290 implements NG-C, Xn-C, F1-C and E1 interfaces. The NG control plane interface (NG-C) is defined between the gNB and Core Access and Mobility Management Function (AMF) entity in the NG-Core. The Xn control plane interface (Xn-C) is defined between the gNBs. The F1 control plane interface (F1-C) is defined between the gNB-CU-CP and NR gNB-DU entity. The E1 is a control plane interface and is defined between the gNB-CU-CP and the NR gNB-CU-UP entities. From logical perspective, the E1 is a point-to-point interface between a gNB-CU-CP and a gNB-CU-UP. The control plane protocol stack 1292 of the NG, Xn, F1 and E1 interfaces is shown in FIG. 12B. The underlying transport network layer may be built on IP (Internet Protocol) transport. For the reliable transport of control plane signaling messages, Stream Control Transmission Protocol (SCTP) is added on top of IP. The SCTP layer provides the guaranteed delivery of application layer messages. The application layer signaling protocols for the NG, Xn, F1 and E1 interfaces are referred to as NG-AP (NG Application Protocol), Xn-AP (Xn Application Protocol), F1-AP (F1 Application Protocol) and E1-AP (E1 Application Protocol) respectively.

The NG user plane (NG-U) interface is defined between the gNB-CU-UP and the UPF (User Plane Function) entity in the NG-Core. The Xn user plane (Xn-U) interface is defined between the gNB-CU-UP of one gNB and the gNB-CU-UP entity of another gNB. The F1 user plane (F1-U) interface is defined between the gNB-CU-UP of one gNB and the gNB-CU-UP entity of another gNB. For the user plane interfaces protocol stack 1290, the transport network layer (TNL) is based on IP transport, comprising the UDP (User Datagram Protocol) and the GPRS tunneling protocol user plane (GTP-U) on top of IP. A key benefit of separating the user plane gNB-CU-UP and integrating it with the RRH and gNB-DU in the virtualized radio base station is that the compute-intensive transport network layer (TNL) GTP-U/UDP/IP processing only needs to happen either in the virtualized radio base stations or the NG-Core. This effectively reduces GTP-U/UDP/IP processing steps for transfer of user data between the NG-Core and the radio base stations.

FIG. 12C illustrates control and user plane separation in one embodiment of the virtualized radio base station network where the user plane function (UPF) of the 5G Next Generation Packet Core (NG-Core) is integrated and virtualized in the virtualized radio base station 1204 and the virtualized radio base station 1206 in a distributed architecture. In this architecture, there is a full CP (Control Plane) & UP (User Plane) split in the core network, i.e. UPF supports user plane data processing, while all other nodes such as Access and Mobility Management function (AMF), Session Management function (SMF), Policy Control Function (PCF), Authentication Server Function (AUSF), Unified Data Management (UDM), Application Function (AF), Network Exposure function (NEF), NF Repository function (NRF) and Network Slice Selection Function (NSSF) act as control plane functions. UPF performs functions such as packet routing & forwarding, packet inspection, QoS handling, acts as external PDU session point of interconnect to Data Network (DN), and is an anchor point for intra- & inter-RAT (Radio Access Technology) mobility. The user plane function (UPF) 1230 in the virtualized radio base station 1204 communicates with the Internet or the Data Network (DN) 1240 on the N6 reference point. The user plane function (UPF) 1232 in the virtualized radio base station 1206 also directly communicates with the Internet or the Data Network (DN) 1240 on the N6 reference point. Functions like Deep Packet Inspection, Caches, Video optimization, TCP optimization, NAT (Network Address Translation) and Firewall can be deployed on the N6 reference point between the UPF and the Internet or the Data Network (DN) 1240. In other embodiments, some of these functions can be co-located with the user plane functions (UPFs) in the virtualized radio base stations.

The user plane function (UPF) 1230 in the virtualized radio base station1204 communicates with the user plane function (UPF) 1232 in the virtualized radio base station1206 on the N9 reference point. The N9 reference point can use GTP-U (GPRS Tunneling Protocol User Plane) protocol or drop in SRv6 (Segment Routing IPv6) to replace GTP-U (GPRS Tunneling Protocol User Plane) in data plane without changing the control plane. Segment routing enables source routing where the source selects a path over a network, placing an ordered list of 128-bit IPv6 addresses into the header of an IPv6 packet.

The User plane function (UPF) specified in 3GPP 23.501 specifications provides functionalities such as: anchor point for Intra-/Inter-RAT mobility, external PDU Session point of interconnect to Data Network, packet routing & forwarding, packet inspection, user Plane part of policy rule enforcement (e.g. Gating, Redirection, Traffic steering), lawful intercept, traffic usage reporting, QoS handling for user plane, uplink Traffic verification (SDF to QoS Flow mapping), transport level packet marking in the uplink and downlink, downlink packet buffering and downlink data notification triggering, sending and forwarding of one or more “end marker” to the source NG-RAN node, ARP proxying as specified in IETF RFC 1027 and/or IPv6 Neighbor Solicitation Proxying as specified in IETF RFC 4861 functionality for the Ethernet PDUs. The UPF responds to the ARP and/or the IPv6 Neighbor Solicitation Request by providing the MAC address corresponding to the IP address sent in the request.

The disclosed architecture allows the UPF to be distributed and deployed independently from the centralized control plane. Separating the user and control planes in this way guarantees each plane resource to be scaled independently. For example, multiple UPF instances can be scaled flexibly, based on their workloads, interface status, and/or subscribers' capacity demands. The disclosed architecture also allows UPFs to be deployed very close to UEs (User Equipment) to shorten the Round-Trip Time (RTT) and reduce delay jitter between UEs and data network for some applications requiring low latency.

The user plane function (UPF) 1230 in the virtualized radio base station1204 and the user plane function (UPF) 1232 in the virtualized radio base station1206 are controlled by the Session Management Function (SMF) 1284 via the N4 control interface protocol. The Session Management Function (SMF) 1284 is part of the 5G Next Generation Packet Core (NG-Core) 1280 and it controls various functionalities related to subscriber sessions, e.g. session management (session establishment, modification, release), UE IP address allocation & management, Dynamic Host Configuration Protocol (DHCP) functions, termination of NAS signaling related to session management, downlink data notification, traffic steering configuration for UPF for proper traffic routing etc.

The central unit control plane (CU-CP) 1220 is virtualized and located at a central location such as a central office or operator's data center. The central unit control plane (CU-CP) 1220 interfaces to the Access & Mobility Management Function (AMF) 1282 in the 5G Next Generation Packet Core (NG-Core) 1280 via the NG-C control interface protocol.

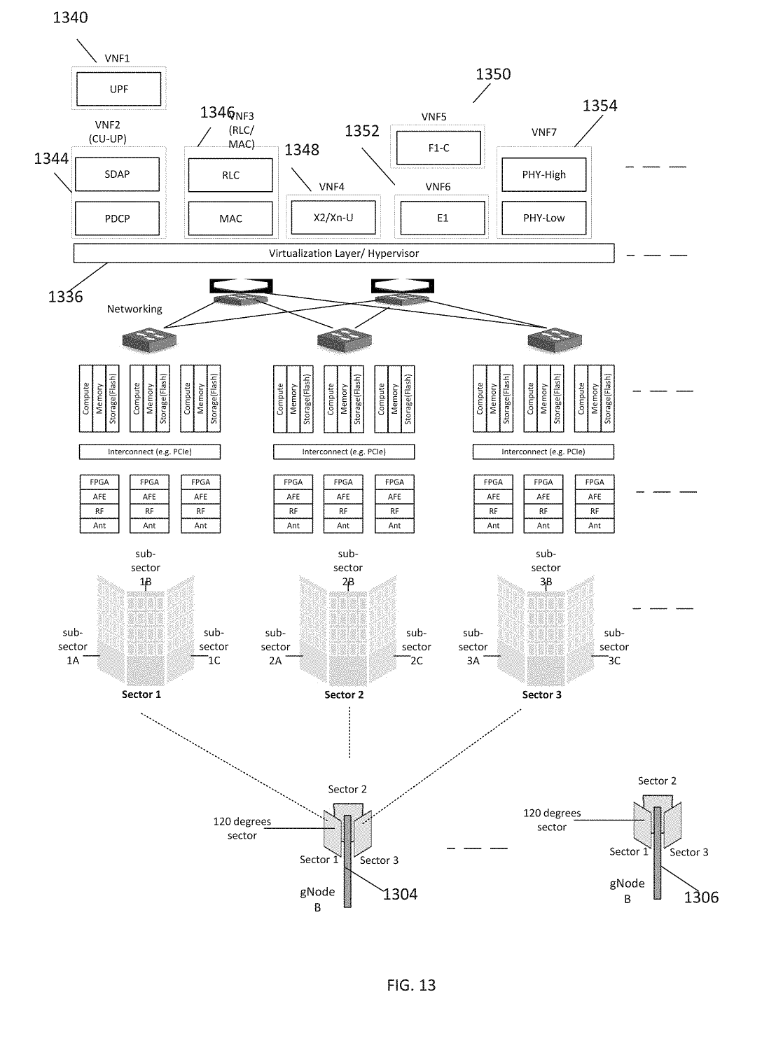

FIG. 13 illustrates virtualization of protocols and network interfaces according to an embodiment of the present disclosure. The user plane function (UPF) of the 5G Next Generation Packet Core (NG-Core) is implemented as a first virtual network function 1340 (VNF1). The central unit user plane (CU-UP) consisting of Service Data Adaptation Protocol (SDAP) and Packet Data Convergence Protocol (PDCP) functions are implemented as a second virtual network function 1344 (VNF2). A single virtual network function may implement many virtual machines. The Radio Link Control (RLC) and Medium Access Control (MAC) protocols are implemented as third virtual network function 1346 (VNF3). The X2-U or Xn-U protocols are implemented as fourth virtual network function 1348 (VNF4). The F1-C protocols are implemented as fifth virtual network function 1350 (VNF5). The E1 protocols are implemented as sixth virtual network function 1352 (VNF6). The higher physical (PHY-high) layer and lower physical (PHY-high) layer functions are implemented as seventh virtual network function 1354 (VNF7). In other embodiments, same functions can be implemented in more than one virtual network functions (VNFs) where each VNF may implement multiple virtual machine. In other embodiments, containers can be used instead of virtual machine. The software that provides the VNFs may be structured into software components that are packaged into one or more images. These software components are called VNF Components (VNFCs). VNFs are implemented with one or more VNFCs and it is assumed that VNFC instances map 1:1 to VM (Virtual Machine) Images.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

1. A virtualized radio base station node, comprising:
a plurality of radio units comprising:
a central unit (CU) comprising:
a central unit user plane (CU-UP) located in at least one of the radio units, the central unit user plane (CU-UP) including a first Packet Data Convergence Protocol (PDCP) layer and a Service Data Adaptation Protocol (SDAP) layer connected to the first Packet Data Convergence Protocol (PDCP) layer; and
a central unit control plane (CU-CP) located remotely from the central unit user plane (CU-UP), the central unit control plane (CU-CP) including a second Packet Data Convergence Protocol (PDCP) layer and a Radio Resource Control (RRC) layer connected to the second Packet Data Convergence Protocol (PDCP) layer,
wherein the central unit user plane (CU-UP) and the central unit control plane (CU-CP) communicate with each other via an interface protocol, and wherein the central unit user plane (CU-UP) and the central unit control plane (CU-CP) are virtualized and shared by the plurality of radio units.

2. The virtualized base station node of claim 1, wherein the central unit user plane (CU-UP) and the central unit control plane (CU-CP) communicate with each other via an E1 interface protocol.

3. The virtualized base station node of claim 1, further comprising:
a remote radio head including a lower physical layer (PHY-Low), an analog-to-digital converter (ADC), a digital-to-analog converter (DAC), MIMO antenna arrays, and a radio frequency (RF) transceiver; and
a distributed unit connected to the remote radio head, the distributed unit including a Radio Link Control (RLC) layer, a Medium Access Control (MAC) layer, and a higher physical (PHY-high) layer,
wherein the remote radio head, the distributed unit and the central unit user plane (CU-UP) are integrated into the radio units, and wherein the central unit control plane (CU-CP) is located remotely from the remote radio head and the distributed unit.

4. The virtualized base station node of claim 1, wherein the radio base station node is a 5G NR (New Radio) base station Node B (gNodeB).

5. The virtualized base station node of claim 1, wherein the distributed unit is a gNodeB distributed unit (gNB-DU).

6. The virtualized base station node of claim 1, wherein the central unit control plane (CU-CP) communicates with the gNB-DU via F1-C(F1 control plane) protocol standardized by 3 GPP.

7. The virtualized base station node of claim 1, wherein a first central unit user plane (CU-UP) communicates with a second central unit user plane (CU-UP) via Xn user plane (Xn-U) protocol standardized by 3GPP.

8. The virtualized base station node of claim 1, further comprising a NG control plane interface (NG-C) between the gNodeB central unit control plane (gNB-CU-CP) and a Core Access and Mobility Management Function (AMF) module in a NG-Core network.

9. The virtualized base station node of claim 1, further comprising a NG user plane (NG-U) interface between the gNodeB central unit user plane (gNB-CU-UP) and an UPF (User Plane Function) module in a NG-Core.

10. The virtualized base station node of claim 1, further comprising an F1 user plane (F1-U) interface between the gNB-CU-UP and the gNB-DU.

11. The virtualized base station node of claim 1, further comprising an Xn user plane (Xn-U) interface between the gNB-CU-UP of one gNode B and the gNB-CU-UP of another gNodeB.

12. The virtualized base station node of claim 1, wherein the virtualized radio base station node is connected to a 4G LTE radio base station enhanced Node B (LTE eNB), and wherein the virtualized radio base station node communicates with the 4G LTE eNB using a X2-U (X2 user-plane) protocol standardized by 3GPP.

13. The virtualized base station node of claim 1, wherein the radio base station node is connected to a 4G LTE Evolved Packet Core (EPC), and wherein the virtualized radio base station node communicates with the 4G LTE Evolved Packet Core (EPC) using a S1-U protocol standardized by 3GPP.

14. The virtualized base station network of claim 1, wherein the central unit user plane (CU-UP) including the first Packet Data Convergence Protocol (PDCP) layer and the Service Data Adaptation Protocol (SDAP) layer are implemented as one or more virtual machines.

15. The virtualized base station network of claim 1, wherein the central unit control plane (CU-CP) including the second Packet Data Convergence Protocol (PDCP) layer and the Radio Resource Control (RRC) layer are implemented as one or more virtual machines.

16. The virtualized base station network of claim 1, wherein the central unit user plane (CU-UP) including the first Packet Data Convergence Protocol (PDCP) layer and the Service Data Adaptation Protocol (SDAP) layer are implemented as one or more containers.

17. The virtualized base station network of claim 1, wherein the central unit control plane (CU-CP) including the second Packet Data Convergence Protocol (PDCP) layer and the Radio Resource Control (RRC) layer are implemented as one or more containers.

18. A virtualized radio base station node, comprising:
a plurality of radio units comprising:
a remote radio head including a lower physical layer (PHY-Low), an analog-to-digital converter (ADC), a digital-to-analog converter (DAC), MIMO antenna arrays, and a radio frequency (RF) transceiver;
a distributed unit connected to the remote radio head, the distributed unit including a Radio Link Control (RLC) layer, a Medium Access Control (MAC) layer, and a higher physical (PHY-high) layer; and
a central unit (CU) connected to the distributed unit, the central unit comprising a central unit user plane (CU-UP) and a central unit control plane (CU-CP), wherein the central unit user plane (CU-UP) includes a first Packet Data Convergence Protocol (PDCP) layer and a Service Data Adaptation Protocol (SDAP) layer, and wherein the central unit control plane (CU-CP) includes a second Packet Data Convergence Protocol (PDCP) layer and a Radio Resource Control (RRC) layer,
wherein the remote radio head (RRH), the distributed unit (DU), and the central unit user plane (CU-UP) are located in at least one of the radio units, and wherein the central unit control plane (CU-CP) is physically separated from the central unit user plane (CU-UP) and is located remotely from the central unit user plane (CU-CP), and wherein the central unit user plane (CU-UP) and the central unit control plane (CU-CP) communicate with each other via an interface protocol, and wherein the remote radio head, the distributed unit and the central unit are virtualized and shared by the plurality of radio units.

19. The virtualized base station node of claim 18, wherein the central unit user plane (CU-UP) and the central unit control plane (CU-CP) communicate with each other via an E1 interface protocol.

20. The virtualized base station node of claim 18, wherein the radio base station node is a 5G NR (New Radio) base station NodeB (gNB).

21. The virtualized base station node of claim 18, wherein the distributed unit is a gNodeB distributed unit (gNB-DU).

22. The virtualized base station node of claim 18, wherein the central unit control plane (CU-CP) communicates with the gNB-DU via F1-C(F1 control plane) protocol standardized by 3GPP.

23. The virtualized base station node of claim 18, wherein a first central unit user plane (CU-UP) communicates with a second central unit user plane (CU-UP) via Xn user plane (Xn-U) protocol standardized by 3GPP.

24. The virtualized base station node of claim 18, further comprising a NG control plane interface (NG-C) between the gNodeB central unit control plane (gNB-CU-CP) and a Core Access and Mobility Management Function (AMF) module in a NG-Core network.

25. The virtualized base station node of claim 18, further comprising a NG user plane (NG-U) interface between the gNB-CU-UP and an UPF (User Plane Function) module in a NG-Core network.

26. The virtualized base station node of claim 18, further comprising an F1 user plane (F1-U) interface between the gNB-CU-UP and the gNB-DU.

27. The virtualized base station node of claim 18, further comprising an Xn user plane (Xn-U) interface between the gNB-CU-UP of one gNode B and the gNB-CU-UP of another gNodeB.

28. The virtualized base station node of claim 18, wherein the virtualized radio base station node is connected to a 4G LTE radio base station enhanced Node B (LTE eNB), and wherein the virtualized radio base station node communicates with the 4G LTE eNB using a X2-U (X2 user-plane) protocol standardized by 3GPP.

29. The virtualized base station node of claim 18, wherein the radio base station node is connected to a 4G LTE Evolved Packet Core (EPC), and wherein the virtualized radio base station node communicates with the 4G LTE Evolved Packet Core (EPC) using a S1-U protocol standardized by 3GPP.

30. The virtualized base station network of claim 18, wherein the central unit user plane (CU-UP) including the first Packet Data Convergence Protocol (PDCP) layer and the Service Data Adaptation Protocol (SDAP) layer are implemented as one or more virtual machines.

31. The virtualized base station network of claim 18, wherein the central unit control plane (CU-CP) including the second Packet Data Convergence Protocol (PDCP) layer and the Radio Resource Control (RRC) layer are implemented as one or more virtual machines.

32. The virtualized base station network of claim 18, wherein the central unit user plane (CU-UP) including the first Packet Data Convergence Protocol (PDCP) layer and the Service Data Adaptation Protocol (SDAP) layer are implemented as one or more containers.

33. The virtualized base station network of claim 18, wherein the central unit control plane (CU-CP) including the second Packet Data Convergence Protocol (PDCP) layer and the Radio Resource Control (RRC) layer are implemented as one or more containers.

34. A virtualized radio base station node, comprising:
a plurality of radio units comprising:
a central unit (CU) comprising:
a central unit user plane (CU-UP) located in at least one of the radio units, the central unit user plane (CU-UP) including a first Packet Data Convergence Protocol (PDCP) layer and a Service Data Adaptation Protocol (SDAP) layer connected to the first Packet Data Convergence Protocol (PDCP) layer; and
a central unit control plane (CU-CP) located remotely from the central unit user plane (CU-UP), the central unit control plane (CU-CP) including a second Packet Data Convergence Protocol (PDCP) layer and a Radio Resource Control (RRC) layer connected to the second Packet Data Convergence Protocol (PDCP) layer,
a user plane function (UPF) of a 5G Next Generation Packet Core (NG-Core) connected to the central unit user plane (CU-UP),
wherein the central unit user plane (CU-UP) and the central unit control plane (CU-CP) communicate with each other via an interface protocol, and wherein the central unit user plane (CU-UP), the central unit control plane (CU-CP) and the user plane function (UPF) of the 5G next Generation Packet Core (NG-Core) are virtualized and shared by the plurality of radio units.

35. The virtualized base station node of claim 34, wherein the user plane function (UPF) of a 5G Next Generation Packet Core (NG-Core) is integrated in the base station node.

36. The virtualized base station node of claim 34, wherein the user plane function (UPF) of a 5G Next Generation Packet Core (NG-Core) is implemented as one or more virtual machines.

37. The virtualized base station network of claim 34, wherein the central unit user plane (CU-UP) including the first Packet Data Convergence Protocol (PDCP) layer and the Service Data Adaptation Protocol (SDAP) layer are implemented as one or more virtual machines.

38. The virtualized base station network of claim 34, wherein the central unit control plane (CU-CP) including the second Packet Data Convergence Protocol (PDCP) layer and the Radio Resource Control (RRC) layer are implemented as one or more virtual machines.

39. A method for wireless communication, comprising:
receiving a first uplink signal at a first virtualized radio unit;
receiving a second uplink signal at a second virtualized radio unit,
wherein the first and second uplink signals are processed by one or more virtual machines shared by both the first and second radio units, and
wherein a first virtual machine implements at least one of a central unit user plane (CU-UP) located in at least one of the radio units, the central unit user plane (CU-UP) including a first Packet Data Convergence Protocol (PDCP) layer and a Service Data Adaptation Protocol (SDAP) layer connected to the first Packet Data Convergence Protocol (PDCP) layer, and
wherein a second virtual machine implements at least one of a central unit control plane (CU-CP) located remotely from the central unit user plane (CU-UP), the central unit control plane (CU-CP) including a second Packet Data Convergence Protocol (PDCP) layer and a Radio Resource Control (RRC) layer connected to the second Packet Data Convergence Protocol (PDCP) layer.

40. The method of claim 39, wherein a third virtual machine implements at least one of a user plane function (UPF) of a 5G Next Generation Packet Core (NG-Core) connected to the central unit user plane (CU-UP).

41. The method of claim 39, wherein the first and second uplink signals are transmitted by a user equipment (UE), and wherein the UE switches connection from the first virtualized radio unit to the second virtualized radio unit without a transfer of context information from the first virtualized radio unit to the second virtualized radio unit.

42. The method of claim 39, wherein the first and second virtualized radio units are located in a same radio base station node.

43. The method of claim 39, wherein the first and second virtualized radio units are located in different radio base station nodes.

44. A method for wireless communication, comprising:
transmitting a first downlink signal by a first virtualized radio unit;
transmitting a second downlink signal by a second virtualized radio unit,
wherein prior to transmission the first and second downlink signals are processed by one or more virtual machines shared by both the first and second radio units, and
wherein a first virtual machine implements at least one of a central unit user plane (CU-UP) located in at least one of the radio units, the central unit user plane (CU-UP) including a first Packet Data Convergence Protocol (PDCP) layer and a Service Data Adaptation Protocol (SDAP) layer connected to the first Packet Data Convergence Protocol (PDCP) layer, and
wherein a second virtual machine implements at least one of a central unit control plane (CU-CP) located remotely from the central unit user plane (CU-UP), the central unit control plane (CU-CP) including a second Packet Data Convergence Protocol (PDCP) layer and a Radio Resource Control (RRC) layer connected to the second Packet Data Convergence Protocol (PDCP) layer.

45. The method of claim 44, wherein a third virtual machine implements at least one of a user plane function (UPF) of a 5G Next Generation Packet Core (NG-Core) connected to the central unit user plane (CU-UP).

46. The method of claim 44, further comprising:
transmitting, by the first virtualized radio unit, the first downlink signal to a user equipment (UE);
transmitting, by the second virtualized radio unit, the second downlink signal to the UE during a second time interval,
wherein the UE switches connection from the first virtualized radio unit to the second virtualized radio unit without a transfer of context information from the first virtualized radio unit to the second virtualized radio unit.

47. A non-transitory computer-readable medium having program code recorded thereon, the program code comprising:
program code to receive a first uplink signal at a first virtualized radio unit;
program code to receive a second uplink signal at a second virtualized radio unit,
wherein the first and second uplink signals are processed by one or more virtual machines having program code shared by both the first and second radio units, and
wherein a first virtual machine having program code implements at least one of a central unit user plane (CU-UP) located in at least one of the radio units, the central unit user plane (CU-UP) including a first Packet Data Convergence Protocol (PDCP) layer and a Service Data Adaptation Protocol (SDAP) layer connected to the first Packet Data Convergence Protocol (PDCP) layer, and
wherein a second virtual machine having program code implements at least one of a central unit control plane (CU-CP) located remotely from the central unit user plane (CU-UP), the central unit control plane (CU-CP) including a second Packet Data Convergence Protocol (PDCP) layer and a Radio Resource Control (RRC) layer connected to the second Packet Data Convergence Protocol (PDCP) layer.

48. A non-transitory computer-readable medium having program code recorded thereon, the program code comprising:
program code to receive a first uplink signal at a first virtualized radio unit;
program code to receive a second uplink signal at a second virtualized radio unit,
wherein the first and second uplink signals are processed by one or more virtual machines having program code shared by both the first and second radio units, and
wherein a first virtual machine having program code implements at least one of a central unit user plane (CU-UP) located in at least one of the radio units, the central unit user plane (CU-UP) including a first Packet Data Convergence Protocol (PDCP) layer and a Service Data Adaptation Protocol (SDAP) layer connected to the first Packet Data Convergence Protocol (PDCP) layer, and
wherein a second virtual machine having program code implements at least one of a central unit control plane (CU-CP) located remotely from the central unit user plane (CU-UP), the central unit control plane (CU-CP) including a second Packet Data Convergence Protocol (PDCP) layer and a Radio Resource Control (RRC) layer connected to the second Packet Data Convergence Protocol (PDCP) layer.
